(19) United States
(12) Patent Application Publication
(10) Pub. No.: US 2025/0267598 A1
(43) Pub. Date: Aug. 21, 2025

(54) MECHANISM FOR TRIGGERING SSB TRANSMISSION FOR TRANSITION PERIOD FOR SCELL OPERATION

(71) Applicant: QUALCOMM Incorporated, San Diego, CA (US)

(72) Inventor: Hung Dinh LY, San Diego, CA (US)

(21) Appl. No.: 18/444,294

(22) Filed: Feb. 16, 2024

(51) Int. Cl. H04W 56/00; H04W 72/1273; H04W 72/231; H04W 76/28

(52) U.S. Cl. CPC H04W 56/0015; H04W 72/1273; H04W 72/231; H04W 76/28

(57) ABSTRACT

The apparatus may be a wireless device configured to receive a configuration for SSBs associated with an SCell for a transition period associated with a transition from a deactivated state of the SCell to an activated state of the SCell for the UE, receive an indication that indicates a transmission of a first set of SSBs from the SCell based on the configuration associated with the transition period, and measure, during the transition period, the first set of SSBs from the SCell based on the configuration and the indication.

### TECHNICAL FIELD

The present disclosure relates generally to communication systems, and more particularly, to wireless communication associated with an activation of a secondary cell.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device configured to receive a configuration for synchronization signal blocks (SSBs) associated with a secondary cell (SCell) for a transition period associated with a transition from a deactivated state of the SCell to an activated state of the SCell for the UE, receive an indication that indicates a transmission of a first set of SSBs from the SCell based on the configuration associated with the transition period, and measure, during the transition period, the first set of SSBs from the SCell based on the configuration and the indication.

In an aspect of the disclosure, a method, a computer-readable medium, and an apparatus are provided. The apparatus may be a network or network component configured to output a configuration for SSBs associated with an SCell for a transition period associated with a transition from a deactivated state of the SCell and an activated state of the SCell for a user equipment (UE), output an indication that indicates a transmission of a first set of SSBs from the SCell based on the configuration associated with the transition period, and output, during the transition period, the first set of SSBs from the SCell based on the configuration and the indication.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a first diagram illustrating locations within a slot for SSBs associated with a first subcarrier spacing (SCS) and a second diagram illustrating different locations (and/or location patterns) within a slot for SSBs associated with a second SCS.

FIG. 5 is a diagram illustrating a transition from a deactivated state of an SCell to an activated state of the SCell associated with a first periodicity of an SSB burst (or SSB burst set).

FIG. 6A is a time diagram illustrating example aspects of SSB burst transmissions during a transition period in response to an activation of an SCell in accordance with some aspects of the disclosure.

FIG. 6B is a diagram illustrating a configuration of an SSB burst set during a transition time in accordance with some aspects of the disclosure.

FIG. 7 is a diagram of an enhanced SCell activation/deactivation MAC-CE in accordance with some aspects of the disclosure.

FIG. 8 is a set of diagrams illustrating different ways to trigger a transitory SSB burst set in accordance with some aspects of the disclosure.

FIG. 9 is a diagram illustrating a discontinuous transmission/discontinuous reception (DTX/DRX) mode of operation at a UE in accordance with some aspects of the disclosure.

FIG. 10 is a call flow diagram illustrating a method of activating an SCell and/or triggering a transitory SSB burst set and/or a periodic SSB set in accordance with some aspects of the disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

FIG. 18A is a call flow diagram illustrating a network-based coordination of a transitory SSB burst set in accordance with some aspects of the disclosure.

FIG. 18B is a call flow diagram illustrating a UE-based coordination of a transitory SSB burst set in accordance with some aspects of the disclosure.

FIG. 19 is a set of diagrams illustrating some aspects of an SCell activation.

### DETAILED DESCRIPTION

In some aspects of wireless communication, a wireless device (e.g., a UE) may be capable of communicating with multiple cells. For example, a UE may receive a configuration for carrier aggregation involving multiple cells, e.g., including a primary cell (PCell) and one or more SCells. A PCell may, accordingly, activate one or more SCells for the UE. As a part of activation of the one or more SCells, in some aspects, the UE may monitor for (and measure) one or more SSBs (e.g., monitoring for SSBs in SSB bursts or SSB opportunities). For example, the UE may measure SSBs transmitted by the SCell that is in a different frequency band than the PCell or that is not collocated with the PCell. In some aspects, the SCell may transmit one or more SSBs with a first periodicity (e.g., 20-160 ms) configured for active operation of the SCell (after an initial cell search, or time and/or frequency tracking has completed). However, as part of the initial activation, the UE may use measurements of multiple SSB transmissions to successfully perform the cell search, automatic gain control (AGC), time and/or frequency tracking, layer 1 (L1) and/or layer 3 (L3) measurements, and other functions associated with cell activation. The activation latency may be large due the relatively long periods between SSB transmissions.

Various aspects relate generally to triggering and/or configuring a set of SSBs associated with a transition from a deactivated state of an SCell to an activated state of the SCell. Some aspects more specifically relate to indicating a configuration for aperiodic (e.g., SSBs triggered by transition of the SCell) and periodic SSBs. In some examples, a UE may be configured to receive a configuration for SSBs associated with an SCell for a transition period associated with a transition from a deactivated state of the SCell to an activated state of the SCell for the UE. The UE may also may be configured to receive an indication that indicates a transmission of a first set of SSBs from the SCell based on the configuration associated with the transition period and may measure, during the transition period, the first set of SSBs from the SCell based on the configuration and the indication. In some aspects, a network (e.g., a PCell, a primary SCell (PSCell), or an activated SCell) may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the network may be configured to output, during the transition period, the first set of SSBs from the SCell based on the configuration and the indication.

Particular aspects of the subject matter described in this disclosure can be implemented to realize one or more of the following potential advantages. In some examples, by triggering and/or configuring a set of SSBs associated with a transition from a deactivated state of an SCell to an activated state of the SCell, the described techniques can be used to reduce a latency associated with the transition and/or the activation of the SCell by enabling the UE to make SSB measurements for SCell activation more quickly. For example, the set of SSBs associated with the transition may have a more compact configuration in time, which may enable the UE to measure a higher number of SSBs from the newly activated SCell more quickly and reduce latency for activation of the SCell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

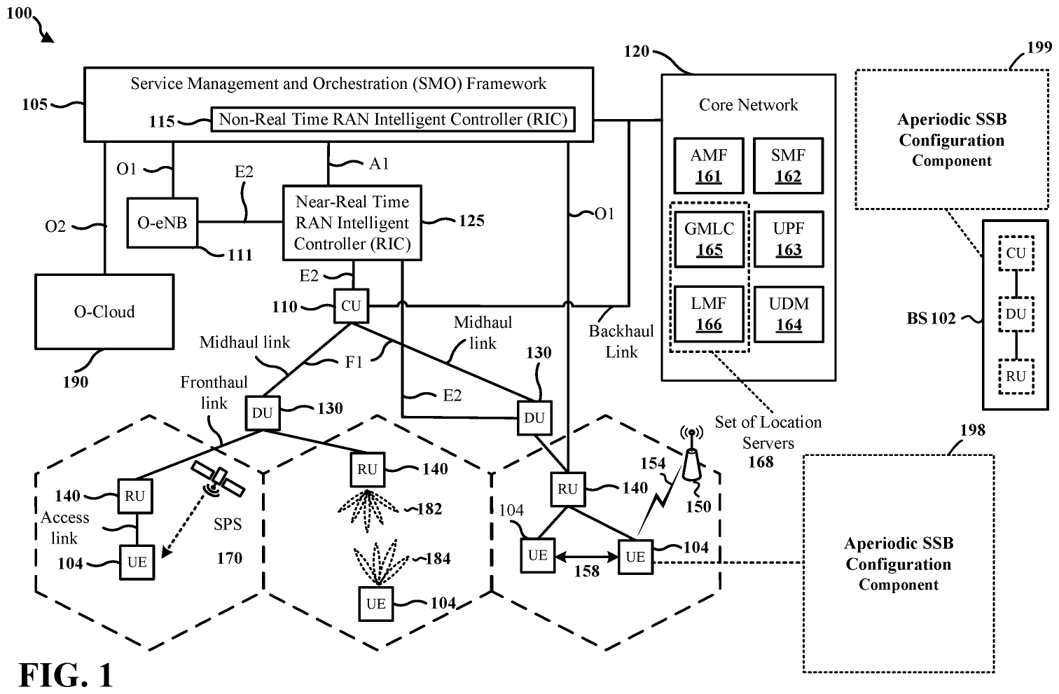

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an aperiodic SSB configuration component 198 that may be configured to receive a configuration for SSBs associated with an SCell for a transition period associated with a transition from a deactivated state of the SCell to an activated state of the SCell for the UE. The aperiodic SSB configuration component 198 may also be configured to receive an indication that indicates a transmission of a first set of SSBs from the SCell based on the configuration associated with the transition period and may measure, during the transition period, the first set of SSBs from the SCell based on the configuration and the indication. In certain aspects, the base station 102 may have an aperiodic SSB configuration component 199 that may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the aperiodic SSB configuration component 199 may be configured to output, during the transition period, the first set of SSBs from the SCell based on the configuration and the indication. Although the following description may be focused on 5G NR, the concepts described herein may be applicable to other similar areas, such as LTE, LTE-A, CDMA, GSM, and other wireless technologies.

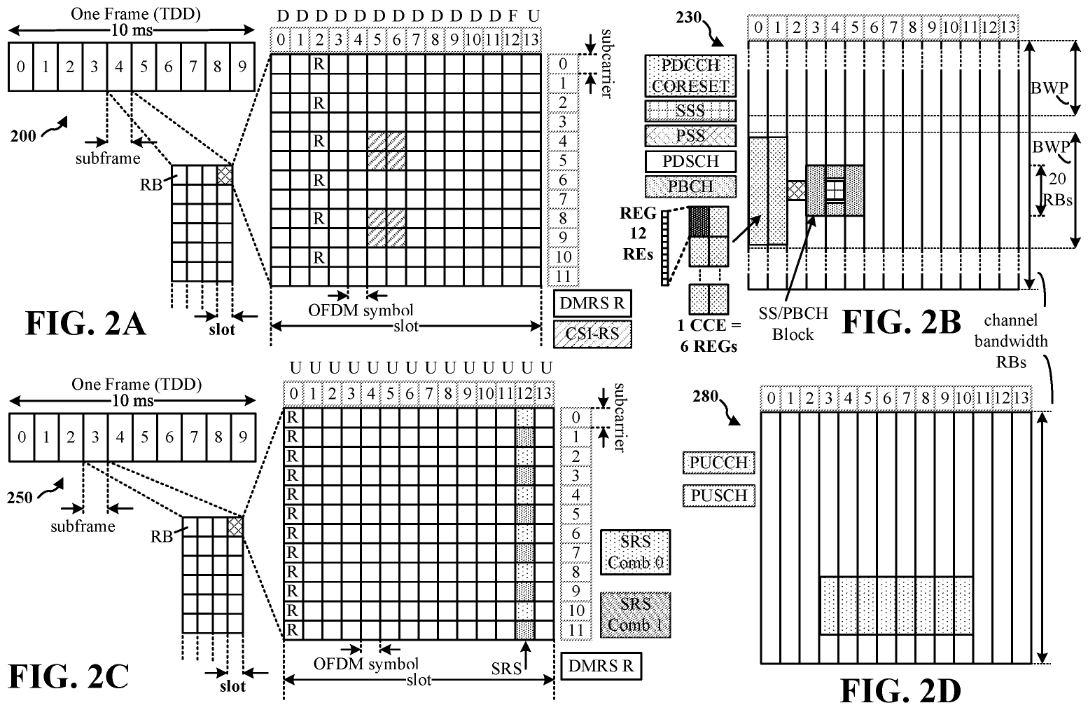

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}* 15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

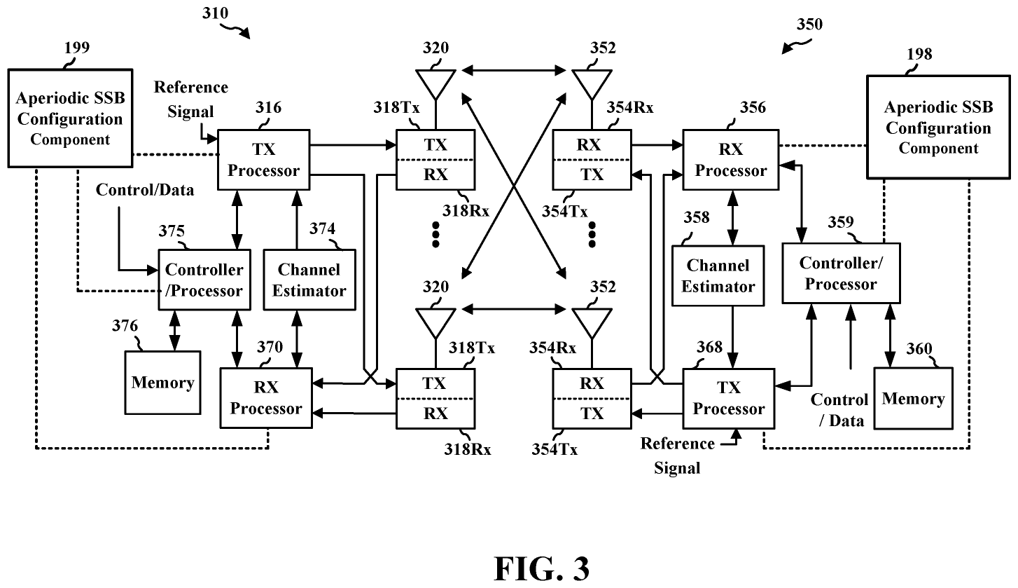

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the aperiodic SSB configuration component 198 of FIG. 1.

At least one of the TX processor 316, the RX processor 370, and the controller/processor 375 may be configured to perform aspects in connection with the aperiodic SSB configuration component 199 of FIG. 1.

In some aspects of wireless communication, a wireless device (e.g., a UE) may be capable of communicating with multiple cells. A PCell may activate, or signal to a UE an activation of, one or more SCells. TWhen an SCell is activated for the UE, in some aspects, the UE may monitor for (and measure) one or more SSBs (in SSB bursts or SSB opportunities) from the SCell. In some aspects, the SCell may transmit the one or more SSBs with a first periodicity (e.g., 20-160 ms) configured for active operation of the SCell (e.g., after an initial cell search, or time and/or frequency tracking has completed). However, for the initial activation, the UE may measure multiple SSB transmissions to successfully perform the cell search and/or the time and/or frequency tracking. The activation latency of the SCell may be large due the relatively long period between SSB transmissions.

As described above in relation to the example of an SSB in FIG. 2B, an SSB may include a PSS, an SSS and a PBCH. As an example, the SSB may include one symbol including a PSS, one symbol including an SSS, and 2 or more symbols including PBCH. FIG. 2B illustrates that the PSS, SSS, and PBCH may be time division multiplexed (TDM) in consecutive symbols of the SSB. FIG. 2B also shows that the PBCH may be frequency division multiplexed (FDM) with the SSB. A time domain mapping may include a PSS symbol, followed by a PBCH symbol, followed by a symbol including SSS and PBCH, followed by another PBCH symbol. Different frequency ranges may be associated with different possible SCS for an SSB. For example, for frequencies below 7 GHZ, an SSB may be associated with one of a 15 kHz or 30 kHz SCS, while for frequencies above 7 GHZ, an SSB may be associated with one of 120 kHz or 240 KHz SCS.

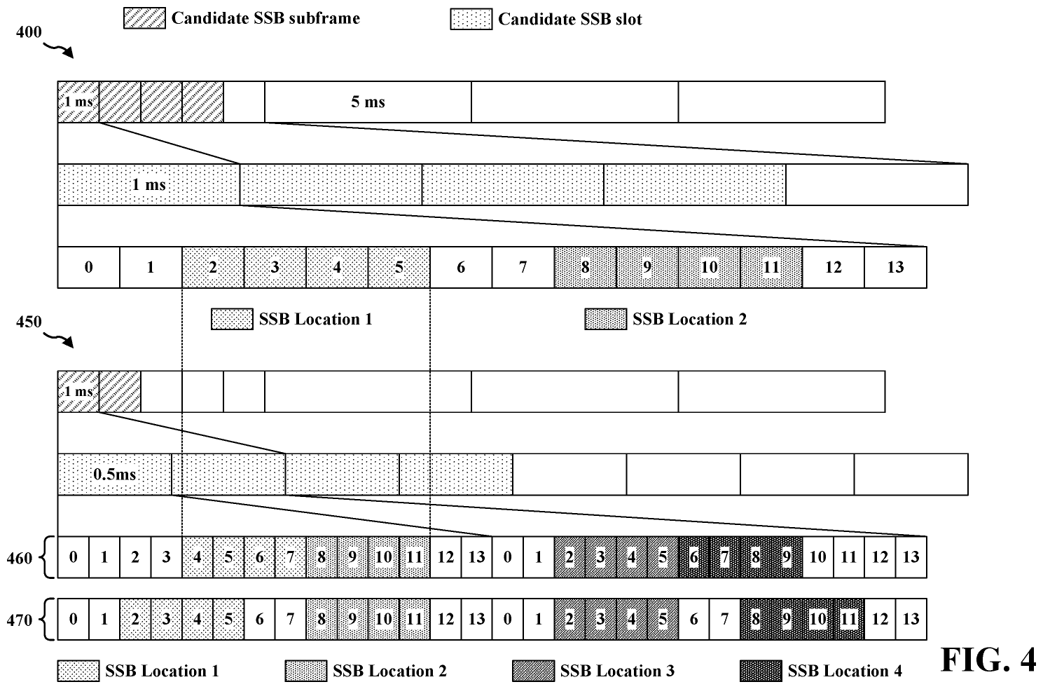

Sets of SSBs may be transmitted in SSB bursts. In some aspects, a transmission of SSBs within an SSB burst may be confined to a 5 ms half-frame. FIG. 4 is a first diagram 400 illustrating locations within a slot for SSBs associated with a first SCS and a second diagram 450 illustrating different locations (and/or location patterns) within a slot for SSBs associated with a second SCS.

Within an SSB burst, the maximum number of possible candidate SSB locations may be a value (“L”) that depends on the carrier frequency. For example, for carrier frequencies up to 3 GHZ, L may take the value 4; for carrier frequencies between 3 GHz and 7 GHZ, L may take the value 8; and for carrier frequencies from 7 GHz to 52.6 GHz (or 7 GHz and above), L may take the value 64. Diagram 400 illustrates a pattern or distribution of SSB opportunities and/or SSB locations within a slot for a first SCS (e.g., 15 kHz SCS). As illustrated in diagram 400, for a first SSB burst associated with 8 SSB opportunities/locations, there are four subframes and/or slots (where a slot and a subframe are each 1 ms for a 15 kHz SCS) that are candidates for including one or more SSBs (for a maximum of 8 SSB opportunities/locations per SSB burst). The four subframes and/or slots, in some aspects may span a first 4 ms within a first half-frame in a set of 4 half frames (e.g., a first 5 ms window in a 20 ms time period). Each of the four candidate slots may include 14 OFDM symbols of which symbols 2-5 are a first SSB opportunity/location and symbols 8-11 are a second SSB opportunity/location.

While the candidate subframes and/or slots are identified for an SSB burst including (or spanning) the maximum number of SSB opportunities/locations, in some aspects, each of the subframes and/or slots in the first 5 ms may be used (e.g., may be a candidate) to transmit an SSB burst comprising up to two SSB transmissions via the two SSB opportunities/locations in the subframe and/or slot. Similarly, a first two subframes and/or slots may be used to transmit a first SSB burst including up to four SSB transmissions via the four SSB opportunities/locations included in the two subframes and/or slots while a second SSB burst may follow in the next two subframes and/or slots (the third and fourth subframes and/or slots) or in two subframes and/or slots (the fourth and fifth subframes and/or slots) following a one-subframe period with no SSB transmissions.

Diagram 450 illustrates two possible patterns or distributions of SSB opportunities and/or SSB locations within a slot for a second SCS (e.g., 30 kHz SCS). As illustrated in diagram 450, there are two subframes corresponding to four slots (where a slot is 0.5 ms and a subframe is 1 ms for a 30 kHz SCS) that are candidates for including one or more SSBs (for a maximum of 8 SSB opportunities/locations per SSB burst). The four slots, in some aspects may span a first 2 ms within a first half-frame in a set of 4 half frames (e.g., a first 5 ms window in a 20 ms time period). SSB opportunity/location pattern 460 illustrates that each of the four candidate slots may include 14 OFDM symbols and that in each pair of symbols a first slot may include symbols 4-7 as a first SSB opportunity/location and symbols 8-11 as a second SSB opportunity/location (where the duration and location in time of the first and second SSB opportunities/locations corresponds to the time and duration of the first SSB opportunity/location for a 15 kHz SCS). Similarly, the second slot may include symbols 2-6 as a third SSB opportunity/location and symbols 7-10 as a fourth SSB opportunity/location (where the duration and location in time of the third and fourth SSB opportunities/locations corresponds to the time and duration of the second SSB opportunity/location for a 15 kHz SCS). SSB opportunity/location pattern 470 illustrates that each of the four candidate slots may include 14 OFDM symbols of which symbols 2-5 are a first SSB opportunity/location and symbols 8-11 are a second SSB opportunity/location (where the pattern is similar to the pattern used for a 15 kHz SCS).

In some aspects, an SSB burst may be associated with a fixed number of adjacent SSB transmissions and may be associated with an indication of SSB opportunities/locations for which an SSB is transmitted. An SSB burst, in some aspects, may additionally be indicated to be part of an SSB burst set of similarly configured SSB bursts associated with a periodicity (or period) of the SSB bursts within the SSB burst set.

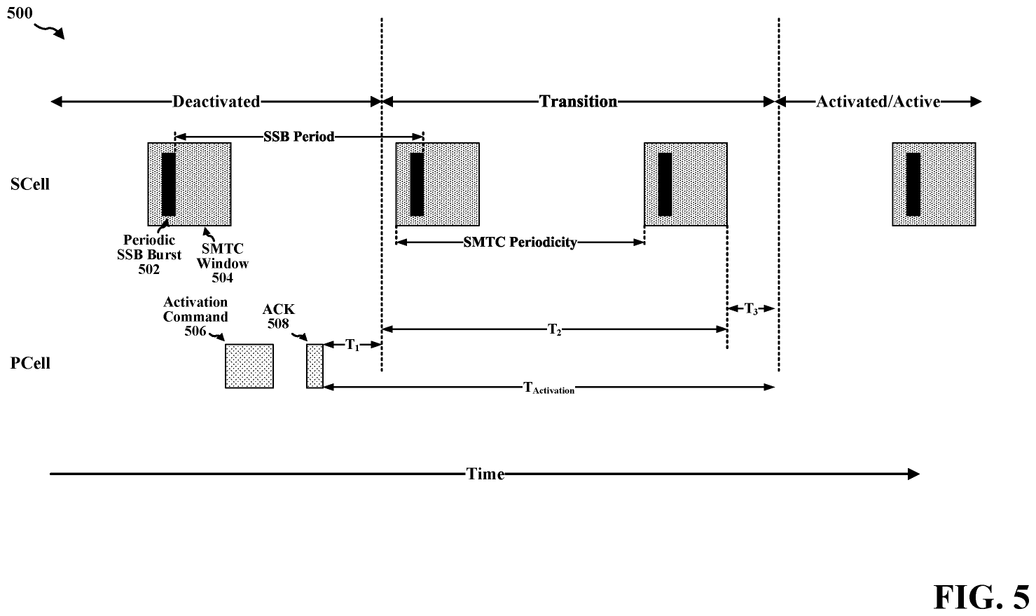

FIG. 5 is a diagram 500 illustrating a transition from a deactivated state of an SCell to an activated state of the SCell associated with a first periodicity of an SSB burst (or SSB burst set) that includes a plurality of SSBs. Each SSB of the plurality of SSBs may include a PSS, SSS, and/or PBCH, such as the example described in connection with FIG. 2B. Diagram 500 illustrates that during a deactivated time period a periodic SSB burst 502 occasion may occur within a measurement time window (e.g., SMTC window 504. In some aspects, each SSB burst (e.g., periodic SSB burst 502) may be associated with one or more SSB opportunities/locations as described in relation to FIG. 4. During the deactivated time period, a UE (and the SCell) may receive an activation command 506 from a network node indicating an activation of the SCell that initiates a transition from the deactivated state to an activated state. The UE may acknowledge the activation command 506 with ACK 508 and a transition period may occur between the activation command and a time at which the SCell is in the activated state. In some aspects, the transition period associated with the SCell activate may begin at a first time offset (T1) from the ACK 508. In order to transition to the activated state, the UE may measure SSB(s) in one or more SSB bursts (periodic SSB bursts with a configured periodicity) spanning an acquisition time (T2) to successfully perform cell search and/or other functions associated with cell activation. As an example, the UE may use the measurements to perform AGC, L1/L3 measurements, or time and/or frequency tracking, among other examples. While illustrated as two SSB bursts to illustrate the concept, in some aspects, the UE may measure SSBs of more than two SSB bursts before successfully performing operations associated with the cell activation. The measurement(s) may be followed by a processing time (T3) based on the measured SSB bursts. After the processing time (T3), the SCell may be activated, which may be referred to as initiating or entering an activated state. The SCell, in some aspects, may continue to transmit the periodic SSB bursts in the activated state (during an activated time).

As illustrated in diagram 500, the period of the SSB bursts, in some aspects, may be consistent across the deactivated state, during the transition period, and during the activated state. In some aspects, the period of the SSB bursts may be modified (the period may be increased) or transmission of the SSB(s) in the SSB bursts may be skipped to conserve power during a deactivated time, while the SSB bursts may be transmitted with a common period (or periodicity) during a transition time and in an activated state. As an example, when the SCell is deactivated, the SCell may skip transmission of SSB(s) in the periodic SSB burst 502. In some aspects, the SCell may transmit a subset of SSBs in the SSB burst 502 in the deactivated time period. The UE may skip monitoring for, or measurement of, the SSB(s) in the periodic SSB burst 502 while the SCell is deactivated.

Various aspects presented herein relate generally to triggering and/or configuring a set of SSBs associated with a transition from a deactivated state of an SCell to an activated state of the SCell, which enables a reduction in latency for the UE to perform the SSB measurements associated with the SCell activation. Some aspects more specifically relate to indicating a configuration for SSBs during a transition state of an SCell that is different from a configuration of SSBs during an activated state of the SCell, where the SSBs may include one or more of periodic, aperiodic, or semi-persistent (e.g., the object of a semi-persistent scheduling (SPS)) SSBs. In some examples, a UE may be configured to receive a configuration for SSBs associated with an SCell for a transition period associated with a transition from a deactivated state of the SCell to an activated state of the SCell for the UE. The UE may also may be configured to receive an indication that indicates a transmission of a first set of SSBs from the SCell based on the configuration associated with the transition period and may measure, during the transition period, the first set of SSBs from the SCell based on the configuration and the indication. In some aspects, a network (e.g., a PCell, a PSCell, or an activated SCell) may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the network may be configured to output, during the transition period, the first set of SSBs from the SCell based on the configuration and the indication.

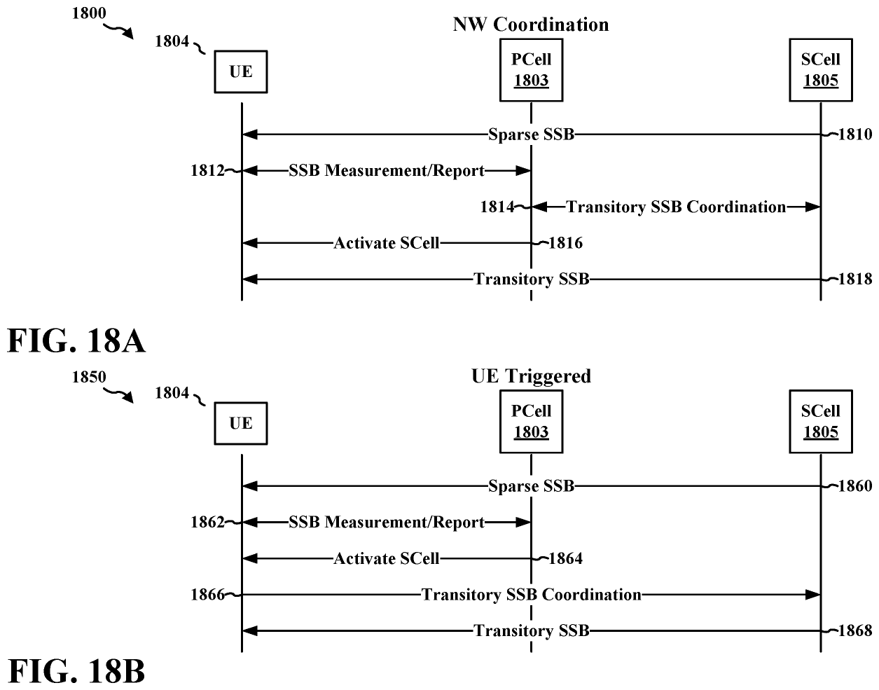

FIG. 18A is a call flow diagram 1800 illustrating a network-based coordination of a transitory SSB burst set in accordance with some aspects of the disclosure. In some aspects, an SCell 1805 may transmit, and UE 1804 may receive, a set of sparse SSBs 1810 while the SCell 1805 is deactivated (or is in a deactivated state). The UE 1804 may measure the sparse SSBs 1810 and exchange SSB measurement and/or report 1812 with a PCell 1803. Based on determining that the SCell 1805 will be activated, the PCell 1803 may exchange transitory SSB coordination messages 1814 with the SCell 1805 to configure and/or determine an allocation for resources for a transitory SSB burst set to be transmitted during a transition time between a deactivated state and an activated state of the SCell 1805. Based on the coordination (e.g., the transitory SSB coordination messages 1814) the PCell 1803 may transmit an SCell activation message 1816. In some aspects, the SCell activation message 1816 may include an indication of the configuration and/or allocation of the resources for the transitory SSB burst set associated with the transition time between a deactivated state and an activated state of the SCell 1805. The SCell 1805 may then output, and the UE 1804 may receive, the transitory SSB burst set 1818 based on the configuration.

FIG. 18B is a call flow diagram 1850 illustrating a UE-based coordination of a transitory SSB burst set in accordance with some aspects of the disclosure. In some aspects, an SCell 1805 may transmit, and UE 1804 may receive, a set of sparse SSBs 1860 while the SCell 1805 is deactivated (or is in a deactivated state). The UE 1804 may measure the sparse SSBs 1860 and exchange SSB measurement and/or report 1862 with a PCell 1803. Based on determining that the SCell 1805 will be activated, the PCell 1803 may transmit an SCell activation message 1864. The UE 1804 may then transmit, and the SCell 1805 may obtain and/or receive, a transitory SSB coordination message 1866 with the SCell 1805 to configure and/or determine an allocation for resources for a transitory SSB burst set to be transmitted during a transition time between a deactivated state and an activated state of the SCell 1805 based on the SCell activation message 1864. Based on the coordination (e.g., the transitory SSB coordination message 1866). The SCell 1805 may then output, and the UE 1804 may receive, the transitory SSB burst set 1868 based on the configuration. As opposed to the network-based coordination that coordinates the transitory SSB burst set configuration before transmitting the SCell activation message 1816, the UE-based method may introduce additional latency for a coordination of a transitory SSB burst set configuration after the SCell activation message 1864.

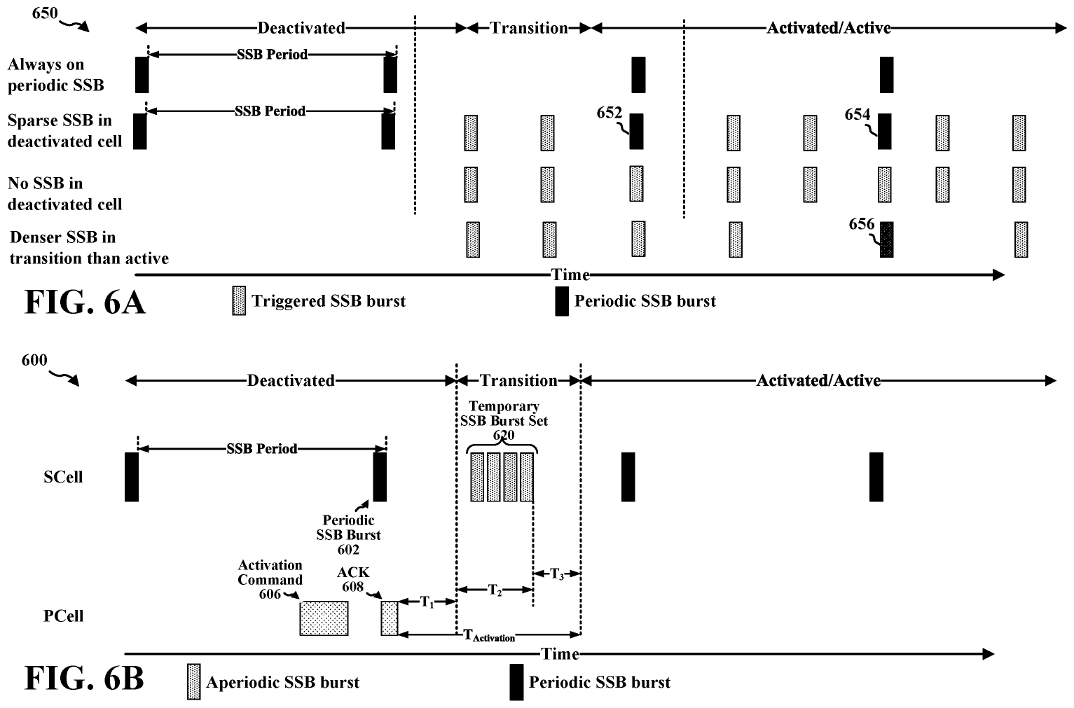

FIG. 6A illustrates an example time diagram 650 showing periodic SSB transmission (e.g., SSB burst transmission) in a deactivated time period, a transition time period, and an activated time period for an SCell. This example may be referred to as an “always on” periodic SSB. As described herein, different SSB transmissions may be triggered during a transition period to enable the UE to make the measurements of the SSBs for SCell activation in a shorter amount of time. In an example showing a sparse SSB when the SCell is deactivated, the SCell may transmit the periodic SSB bursts. During the transition period, the SCell may transmit additional or different SSB bursts. For example, the SCell may transmit one or more triggered SSB bursts during the transition. The “triggered SSB bursts” may also be referred to as “aperiodic” or “semi-persistent” as they are triggered by the transition of the SCell to an activated state. However, once triggered, the additional SSB bursts may be transmitted in a periodic or semi-persistent manner, at least during the transition period. The triggered SSB bursts may also be referred to by other names, such as transitional SSB bursts, conditional SSB bursts, on-demand SSB bursts, or temporary SSB bursts, among other examples. The SCell may continue to transmit the periodic SSB bursts. In some aspects, the parameters of the periodic SSB bursts (e.g., 652, 654, or 656) may be updated to be consistent with the triggered SSB bursts that are triggered upon transition of the SCell to an activated state for the UE.

FIG. 6A also illustrates an example in which there may be no periodic SSB transmission by the SCell during the deactivated state, and an example in which the triggered SSB bursts during the transition period may also be denser in time than the SSB bursts that are transmitted in the activated period.

As described herein, the UE may use the SSBs during the transition period for cell search, AGC and time and/or frequency tracking associated with the SCell activation. Various parameters can be configured, e.g., signaled, to the UE for the SSB bursts during the transition period. As an example, the UE may receive an indication of a frequency where the SSBs will be transmitted (e.g., an absolute radio frequency channel number (ARFCN), and/or an SSB SCS if the frequency band supports multiple SCSs for SSB. The UE may receive an indication of a number of SSB bursts in the set, and periodicity of the bursts or time gap between consecutive bursts. The UE may receive an indication of number of SSBs in a burst. In some aspects, all of the SSBs in the burst may transmitted by the SCell, or the UE may receive an indication of a subset of SSBs that are actually transmitted SSBs. As an example, the UE may receive a configuration of the maximum number of SSBs in a burst and/or a bitmap indicating the subset of SSBs that will be transmitted. The UE may receive an indication of an SMTC window where UE can search/measure (aperiodic) SSB. As an example, the window may have a starting time relative to the timing of the ACK transmitted by the UE for the SCell activation command and a window duration following the starting time.

As described in connection with FIG. 6A, the parameters of the periodic SSB bursts may be adjusted, or configured, to be consistent with the triggered SSB bursts. In addition to the triggered SSB bursts, the UE may use the periodic SSB bursts to perform the measurements associated with the SCell activation (e.g., time and/or frequency tracking, AGC, L1/L3 measurements). One or more of the parameters of the periodic SSB bursts may be configured, or adjusted, based on the transition to the activated state and to be more consistent with the triggered SSB. As an example one or more of a frequency for SSB transmission (e.g., ARFCN), a periodicity of the SSB burst, a number of SSBs in a burst, an indication of SSBs actually transmitted in an SSB burst, an SSB SCS, and/or a time offset to determine a first periodic SSB burst may be indicated to the UE. In some aspects, the parameters for the periodic SSB burst may be the same as, or may correspond to, the parameters for the triggered SSB bursts.

FIG. 6B is a diagram 600 illustrating a configuration of an SSB burst set during a transition time in accordance with some aspects of the disclosure. Diagram 600 illustrates that during a deactivated state the SCell may transmit a periodic SSB burst 602 (or SSB burst set) although, in some aspects, the SCell may omit and/or skip the transmission of the periodic SSB burst 602. The PCell (as an example of an activated cell that may be a PScell or another SCell) may transmit an activation command 606 and receive an ACK 608 to initiate a transmission from a deactivated state to an activated state.

In some aspects, the activation command 606 may be an enhanced SCell activation/deactivation indication. For example, the activation command 606 may include a MAC-CE indicating an activation/deactivation state of a plurality of SCells and an associated configuration for a temporary SSB burst set such as temporary SSB burst set 620. The activation command 606, in some aspects, may be a set of two or more messages. For example, the activation command 606 may include a first MAC-CE indicating an activation/deactivation state of a plurality of SCells and a second MAC-CE or DCI indicating a configuration for a temporary SSB burst set, such as temporary SSB burst set 620. In some aspects, the activation command 606 may include a first MAC-CE indicating a first configuration for a temporary SSB burst set and a subsequently received DCI indicating a second configuration for the temporary SSB burst set that overrides or supersedes the first configuration. By using the temporary SSB burst set 620, the activation time (Tactivation) may be reduced compared to waiting for a sufficient number of periodic SSB bursts.

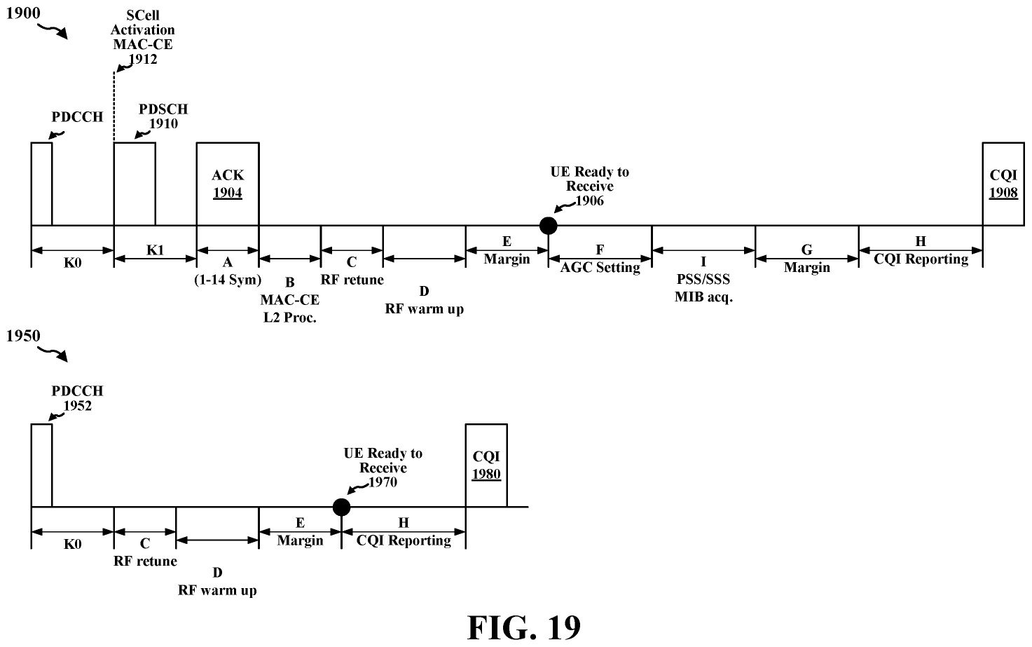

FIG. 19 is a set of diagrams (diagram 1900 and diagram 1950) illustrating some aspects of an SCell activation. Diagram 1900, for example, illustrates that upon receiving a PDSCH 1910 including an SCell activation 1912 (e.g., in a MAC-CE), the UE may send an ACK 1904 at a time based on a value K1, at which point the UE may perform MAC-CE L2 processing (B), an RF retuning (C), an RF warmup (D), and may introduce a margin for software and/or baseband updates (E). The UE may be ready to receive a reference signal or SSB at 1906, and would then receive (and measure) one or more reference signals for AGC setting (F), PSS/SSS MIB acquisition (I), may introduce a margin for SSB processing (G), and then channel quality may be determined and a channel quality indication (CQI) 1908 may be reported (H). Diagram 1950 illustrates an alternative set of operations associated with an SCell that continues to transmit (and a UE that continues to measure) periodic SSB bursts while the SCell is deactivated to reduce latency associated with AGC setting (F), PSS/SSS MIB acquisition (I), the margin for SSB processing (G), and/or the channel quality determination and CQI reporting (H). For example, diagram 1950 illustrates that while a PDCCH 1952 is transmitted, the PDSCH and ACK may be omitted such that the UE is ready to receive a RS and/or SSB at 1970 after an RF retuning (C), an RF warmup (D), and a margin for software and/or baseband updates (E). Additionally, once the UE is ready to receive the RS and/or SSB, it may omit, based on the measurements performed while the SCell was in a deactivated state, the AGC setting (F), PSS/SSS MIB acquisition (I), and/or margin for SSB processing (G) and proceed to the channel quality determination and CQI 1980 reporting (H). While this method may reduce a latency associated with an SCell activation, it may be associated with increased power consumption at both the SCell and the UE.

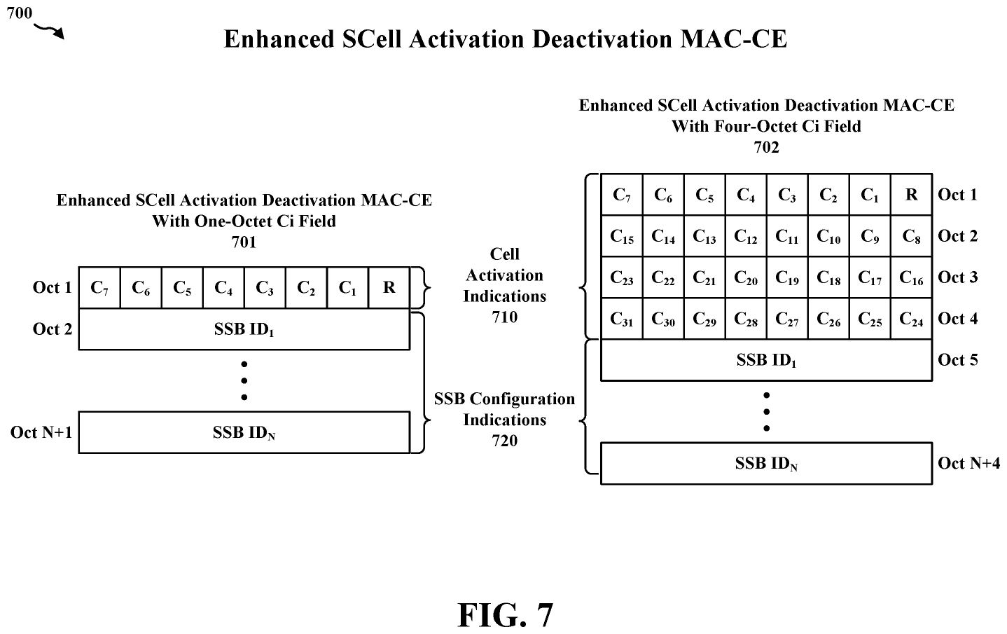

FIG. 7 is a diagram 700 of an enhanced SCell activation/deactivation MAC-CE in accordance with some aspects of the disclosure. The enhanced SCell activation/deactivation MAC CE, in some aspects, may be an enhanced SCell activation/deactivation MAC CE with one-octet Cᵢ field 701 or an enhanced SCell activation/deactivation MAC CE with four-octet Cᵢ field 702. As described in further detail below, an enhanced SCell activation/deactivation MAC CE may have a first set of fields associated with a set of cell activation indications 710 and a second set of fields associated with a set of SSB configuration indications 720. In some aspects, the set of SSB configuration indications 720 may refer to (or identify an SSB configuration from) a known set of SSB configurations. The known set of SSB configurations may include periodic SSB configurations, aperiodic SSB configurations, transitory SSB burst set configurations, or a configuration for a combination of two or more of periodic, aperiodic, and temporary SSB burst sets.

The enhanced SCell activation/deactivation MAC CE with one-octet Cᵢ field 701, in some aspects, may be identified by a MAC subheader with a logical channel identifier (LCID) or enhanced LCID (ELCID) that may be specified for the enhanced MAC-CE. The enhanced MAC-CE may have a variable size and may include seven C-fields, one R-field, and zero or more SSB ID fields in ascending order based on the SCell index for SCells indicated by the Cᵢ field(s) to be activated.

The enhanced SCell activation/deactivation MAC CE with four-octet Cᵢ field 702, in some aspects, may be identified by a MAC subheader with an LCID or eLCID that may be specified for the enhanced MAC-CE. The enhanced MAC-CE may have a variable size and may include 31 C-fields, one R-field, and zero or more SSB ID fields in ascending order based on the SCell index for SCells indicated by the Cᵢ field(s) to be activated. In some aspects, each Cᵢ field may indicate an activation/deactivation state (or status) of an SCell with an SCell index i (e.g., if there is an SCell configured for the MAC entity with the SCell index i). For example, the Cᵢ field may be set to 1 to indicate that the SCell with SCell index i will be activated and that an SSB IDᵢ field is included for the SCell. Alternatively, the Cᵢ field may be set to 0 to indicate that the SCell with SCell index i will be deactivated and that no SSB IDᵢ field is included for the SCell.

The SSB IDᵢ may be a non-zero value indicating a corresponding SSB configuration in the set of SSB configurations (e.g., the set of transitory SSB burst set configurations and/or periodic SSB configurations). The SSB configuration for a particular transitory SSB burst set including a plurality of SSB bursts, in some aspects, may indicate one or more of a frequency associated with the plurality of SSB bursts, a subcarrier spacing associated with the plurality of SSB bursts, a number of SSB bursts in the plurality of SSB bursts, a periodicity or time gap associated with adjacent SSB bursts in the plurality of SSB bursts, a number of SSB occasions associated with transmitted SSBs in each SSB burst in the plurality of SSB bursts, an SSB transmission power, and/or a start time and duration of a measurement window associated with the plurality of SSB bursts. If the SSB ID field is set to 0, in some aspects, it may indicate that no SSB is used for the corresponding SCell. In some aspects, the R field is a reserved bit set to 0.

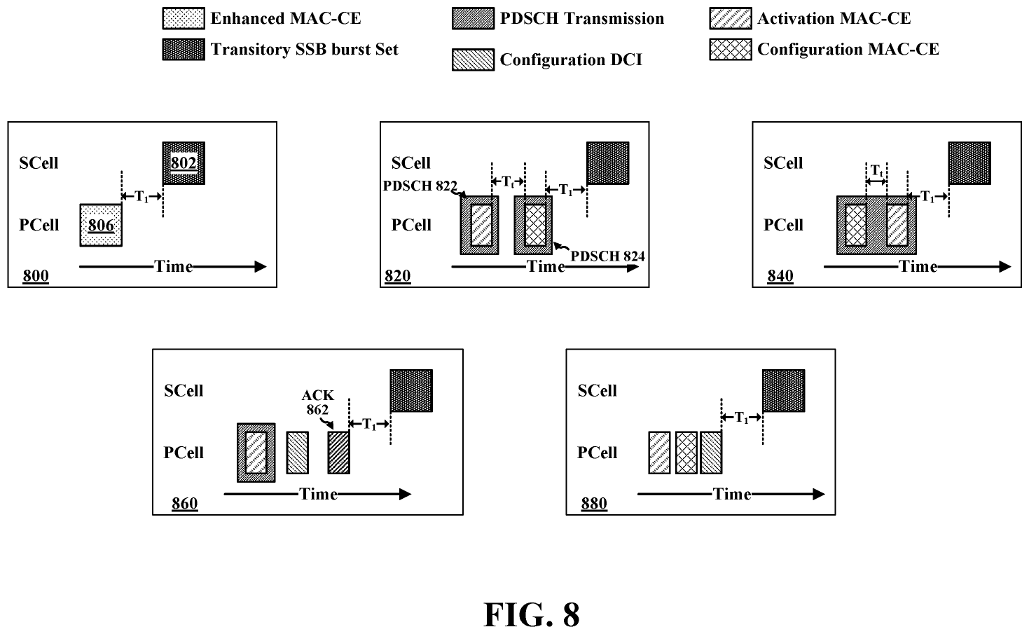

FIG. 8 is a set of diagrams (e.g., diagram 800, diagram 820, diagram 840, diagram 860, and diagram 880) illustrating different ways to trigger a transitory SSB burst set in accordance with some aspects of the disclosure. Diagram 800 illustrates a combined SCell activation and transitory SSB burst set triggering 806 using an enhanced MAC-CE (e.g., one of the enhanced SCell activation/deactivation MAC CE with one-octet Cᵢ field 701 or the enhanced SCell activation/deactivation MAC CE with four-octet Cᵢ field 702). The combined SCell activation and transitory SSB burst set triggering 806 may be followed by a transitory SSB burst set 802 after a configured time T1.

Diagram 820 illustrates a separate activation MAC-CE and configuration MAC-CE (e.g., a MAC-CE triggering a transitory SSB burst set with an indication of a configuration of the transitory SSB burst set). The configuration MAC-CE, in some aspects, may be configured, and/or specified, to be transmitted at, or after, a time (Tt) from the activation MAC-CE. The configuration MAC-CE, may include a configuration of one or more of periodic and/or transitory SSB bursts or SSB burst sets, where the transitory SSB bursts or SSB burst sets may include one or more of periodic or aperiodic resources. As illustrated, the activation MAC-CE and the configuration SSB are transmitted in a first PDSCH transmission 822 and a second PDSCH transmission 824, respectively. In some aspects, both the activation MAC-CE and the configuration MAC-CE may be transmitted in a same PDSCH transmission.

Diagram 840 illustrates a separate activation MAC-CE and configuration MAC-CE (e.g., a MAC-CE triggering a transitory SSB burst set with an indication of a configuration of the transitory SSB burst set). The activation MAC-CE, in some aspects, may be configured, and/or specified, to be transmitted at, or after, a time (Tt) from the configuration MAC-CE. The configuration MAC-CE, may include a configuration of one or more of periodic and/or transitory SSB bursts or SSB burst sets, where the transitory SSB bursts or SSB burst sets may include one or more of periodic or aperiodic resources. As illustrated, the activation MAC-CE and the configuration SSB are transmitted in a same PDSCH transmission. In some aspects, the activation MAC-CE and the configuration MAC-CE may be transmitted in different PDSCH transmissions as illustrated in diagram 820.

Diagram 860 illustrates an activation MAC-CE followed by a configuration DCI. The configuration, in some aspects, may be one of a UE-specific DCI or a UE-group common DCI (e.g., similar to DCI format 2_9 for cell DTX/DRX or DCI format 2_6 for DL wake up signals). In some aspects, the configuration DCI may provide one or more configurations of transitory SSB burst sets for one or more SCells. In some aspects, the DCI may not include configurations for a periodic SSB burst (e.g., during an activated period and/or associated with an activated state (or status) of the SCell). In some aspects, the DCI may be a UE-specific DCI that may or may not include PUSCH and/or PDSCH scheduling. In some aspects, a UE may transmit, and the PCell may receive, a HARQ-ACK 862 in response to the reception of the configuration DCI.

Diagram 880 illustrates an activation MAC-CE, a configuration MAC-CE, and a configuration DCI. In some aspects, the activation MAC-CE and the configuration MAC-CE may be interchangeable with an enhanced MAC-CE. In some aspects, a first configuration for a transitory SSB burst set associated with the SCell activation may be indicated by the configuration MAC-CE and the configuration DCI may be provided to overwrite (e.g., override or supersede) the first configuration with a second configuration for the transitory SSB burst set in association with the SCell activation.

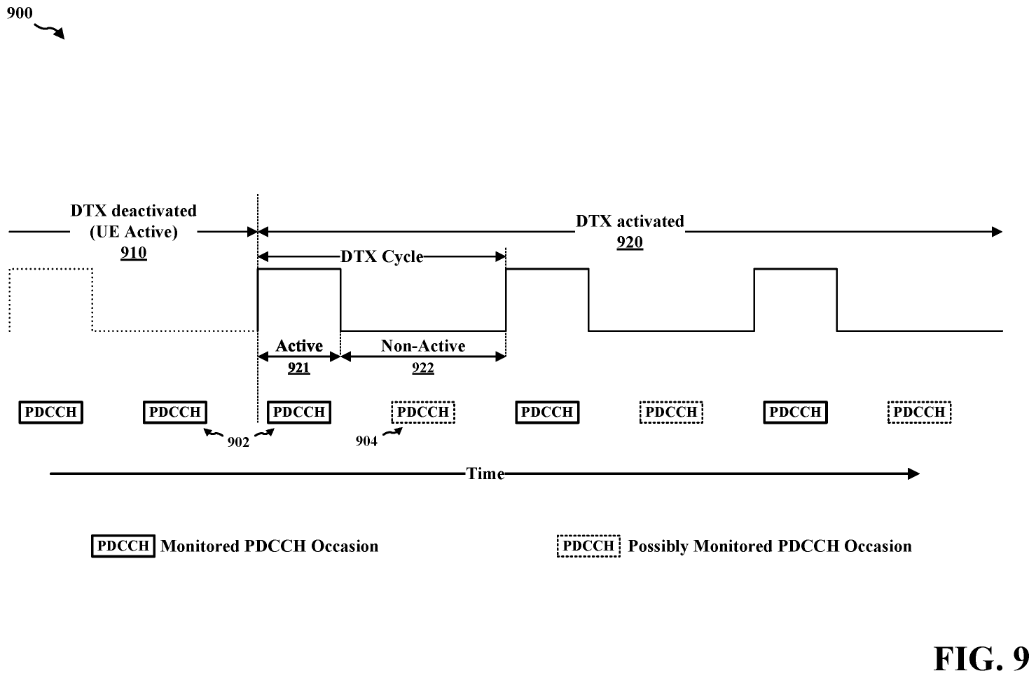

FIG. 9 is a diagram 900 illustrating a DTX/DRX mode of operation at a UE in accordance with some aspects of the disclosure. In some aspects, a cell DTX/DRX may be activated and/or deactivated via RRC or a UE-group common DCI. In some aspects, during a non-active time of a cell DTX/DRX, a UE may skip monitoring for, and does not expect to receive, SPS transmissions, a USS PDCCH, a PDCCH with certain formats such as DCI format 2_X (e.g., where X=0, 1, 2, 3, 4, or 5), periodic or semi-persistent CSI-RS for CSI reports (e.g., including RI). The UE may skip transmission of uplink transmissions, such as transmissions based on a configured grant, scheduling requests, periodic or semi-persistent SRS transmissions (e.g. the UE may transmit SRS for positioning), and/or periodic or semi-persistent CSI reports. For example, when using RRC activation/deactivation, a cell DTX/DRX may be activated when cell DTX/DRX is RRC configured and deactivated when it is released. When using DCI (e.g., a UE-group common DCI or UE-specific DCI), in some aspects, a DCI transmitted in a serving cell may carry an activation/deactivation command for one or multiple serving cells and a UE may monitor the DCI in one serving cell. In some aspects an activation/deactivation command may be applied at least 3 ms after a UE receives the DCI. A UE with an activated DTX/DRX mode of operation that may receive a DCI indicating a configuration for a transitory SSB burst set (e.g., the configuration DCI described in relation to FIG. 8) during a non-active period, may be configured to monitor for a PDCCH (or PDCCH opportunity) that may carry the DCI (e.g., the configuration DCI), or may be configured to skip/omit monitoring for the PDCCH (or PDCCH opportunity). In some aspects, the configuration may be dynamic, such that the UE may be configured by the network (a PCell or other serving cell) to either monitor for or skip/omit monitoring for the PDCCH that may carry the DCI (e.g., the configuration DCI of FIG. 8). For example, during a first time period 910 with DTX/DRX deactivated, or during an active time period 921 of a second time period 920 with DTX/DRX activated, a UE may monitor for each PDCCH opportunity (e.g., PDCCH opportunities 902). During a non-active time period 922 of the second time period 920 with DTX/DRX activated, the UE may be configured to monitor or skip/omit monitoring for PDCCH opportunities (e.g., PDCCH opportunity 904).

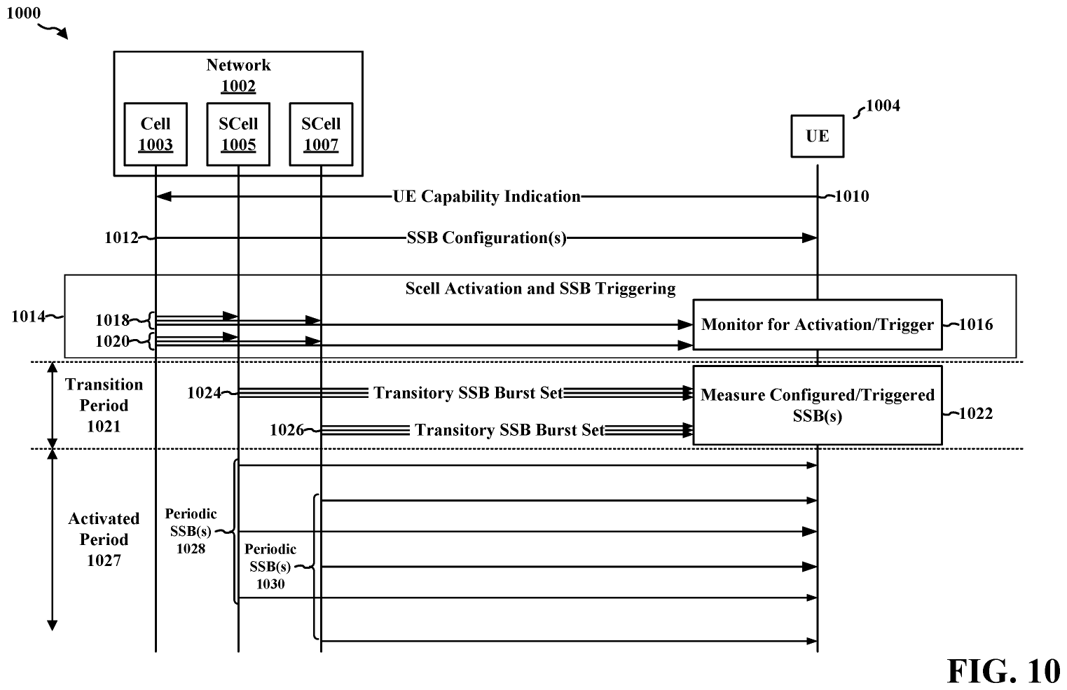

FIG. 10 is a call flow diagram 1000 illustrating a method of activating an SCell and/or triggering a transitory SSB burst set and/or a periodic SSB set in accordance with some aspects of the disclosure. The method is illustrated in relation to a network 1002 associated with a Cell 1003 (e.g., an activated PCell, PSCell, or SCell serving the UE 1004), a first SCell 1005, and a second SCell 1007 (e.g., where the Cell 1003, the first SCell 1005, and the second SCell 1007 may be provided by a network device or network node such as a base station or DU of a base station) in communication with a UE 1004 (e.g., as an example of a wireless device). Aspects performed by the Cell 1003 (e.g., a PCell, PSCell, or SCell) may be performed by a base station in aggregation or by one or more components of a disaggregated base station, for example the actions described as being performed by the Cell 1003 may be performed by an RU, CU, or DU of a disaggregated base station. In some aspects, the first SCell 1005 and the second SCell 1007 may be deactivated at the beginning of the method. The functions ascribed to the network 1002 or a particular cell, in some aspects, may be performed by one or more components of a network entity, a network node, or a network device (a single network entity/node/device or a disaggregated network entity/node/device as described above in relation to FIG. 1) associated with the network 1002. Similarly, the functions ascribed to the UE 1004, in some aspects, may be performed by one or more components of a wireless device supporting communication with a network entity/node/device. Accordingly, references to “transmitting” in the description below may be understood to refer to a first component of the network 1002 (or the Cell 1003, the first SCell 1005, the second SCell 1007, or the UE 1004) outputting (or providing) an indication of the content of the transmission to be transmitted by a different component of the network 1002 (or the Cell 1003, the first SCell 1005, the second SCell 1007, or the UE 1004). Similarly, references to “receiving” in the description below may be understood to refer to a first component of the network 1002 (or the Cell 1003, the first SCell 1005, the second SCell 1007, or the UE 1004) receiving a transmitted signal and outputting (or providing) the received signal (or information based on the received signal) to a different component of the network 1002 (or the Cell 1003, the first SCell 1005, the second SCell 1007, or the UE 1004).

In some aspects, the UE 1004 may transmit, and the network 1002 (e.g., the Cell 1003) may receive, a UE capability indication 1010 indicating support for a transitory SSB burst set. The UE capability indication 1010, in some aspects, may indicate support for one or more SCells per band, per UE (e.g., for a full set of candidate bands), per band combination, or per feature group. In some aspects, the UE capability indication 1010 may also indicate support (per band or per UE) for DCI-based overwriting of a previously received configuration (e.g., via an enhanced MAC-CE or a configuration MAC-CE as described above in relation to FIGS. 7 and 8).

The network 1002 (e.g., via the Cell 1003) may transmit, and the UE 1004 may receive, candidate SSB configurations 1012 indicating one or more configurations for one or more periodic and/or transitory SSB burst sets. The one or more configurations may be associated with indexes used to identify and/or address a triggered and/or selected configuration for a particular SCell. Each of the one or more configurations indicated (or configured by) candidate SSB configurations 1012 may indicate one or more of a frequency associated with transmitted SSBs associated with the configuration, an SCS associated with transmitted SSBs associated with the configuration, a number of SSB bursts associated with the configuration, a periodicity or time gap associated with adjacent SSB bursts or transmitted SSBs associated with the configuration, a location of SSBs transmitted in each SSB burst associated with the configuration (e.g., a bitmap indicating candidate SSB occasions/locations for which an SSB will be transmitted), an SSB transmission power for transmitted SSBs associated with the configuration, and a start time and duration of a measurement window associated with transmitted SSBs associated with the configuration.

Upon determining to activate one or more SCells, e.g., SCell 1005 and SCell 1007, the network 1002 (e.g., via Cell 1003) may perform an SCell activation and SSB triggering 1014. The SCell activation and SSB triggering 1014, in some aspects, may include a UE 1004 monitoring, at 1016, for one or more sets of messages associated with SCell activation and/or SSB transmission triggering, e.g., messages 1018 and 1020. In some aspects, the UE 1004 may be configured to monitor, at 1016, for one of the messages 1018 and/or 1020, in a PDCCH associated with a configuration DCI even if a DTX/DRX mode of operation is activated and the UE 1004 is in a non-active time period. The UE 1004, in some aspects, may be configured to omit and/or skip monitoring for the PDCCH associated with a configuration DCI if a DTX/DRX mode of operation is activated and the UE 1004 is in a non-active time period, but as no transitory SSB is triggered, such a case is not illustrated in diagram 1000. Based on the UE 1004 monitoring for the messages 1018 and/or messages 1020, the network 1002 (e.g., via Cell 1003) may output and/or transmit, and the UE 1004, the first SCell 1005, and the second SCell 1007, may obtain and/or receive one or more of the messages 1018 and 1020.

In some aspects the message 1018 may be an enhanced SCell activation/deactivation MAC-CE indicating an activated or deactivated state for one or more SCells (e.g., one or both of the first SCell 1005 and the second SCell 1007) configured for one or more UEs and an associated SSB configuration from the one or more configurations indicated and/or configured by candidate SSB configurations 1012. If the message 1018 is an enhanced SCell activation/deactivation MAC-CE, the message 1020 may be omitted or, if the first SCell 1005 (but not the second SCell 1007) is activated, the message 1020 may be an additional enhanced SCell activation/deactivation MAC-CE additionally activating the second SCell 1007 and triggering an SSB transmission associated with the second SCell 1007. Alternatively, the message 1020 may be a configuration DCI to overwrite (e.g., modify or supersede) an SSB configuration indicated in the message 1018 associated with either, or both, of the first SCell 1005 and the second SCell 1007.

Alternatively, the messages 1018 may be an SCell activation/deactivation MAC-CE indicating an activated or deactivated state for one or more SCells configured for one or more UEs and the messages 1020 may be one of a configuration MAC-CE or a configuration DCI indicating one or more SSB configurations for one or more SCells activated by the message 1018. For example, message 1018 may be an SCell activation/deactivation MAC-CE indicating an activated state for the first SCell 1005 and the second SCell 1007 and the message 1020 may indicate (e.g., via a configuration MAC-CE or a configuration DCI) one or more of a transitory SSB burst set configuration (for transitory SSB burst set 1024 and transitory SSB burst set 1026) and/or a periodic SSB configuration (for periodic SSBs 1028 and periodic SSBs 1030) for each of the first SCell 1005 and the second SCell 1007. In some aspects, the order of activation message and triggering message may be reversed such that the messages 1018 indicate, or trigger, the SSB configurations, while the messages 1020 indicate the activation state of the one or more SCells.

Based on the message 1018 and/or messages 1020, the UE 1004 may, during transition period 1021, measure, at 1022, configured and/or triggered SSBs (e.g., transitory SSB burst set 1024 and/or transitory SSB burst set 1026). Transitory SSB burst set 1024 may be associated with a first set of values for one or more of a frequency associated with transitory SSB burst set 1024, an SCS associated with transitory SSB burst set 1024, a number of SSB bursts associated with transitory SSB burst set 1024, a periodicity or time gap associated with adjacent SSB bursts or transmitted SSBs associated with transitory SSB burst set 1024, a location of SSBs transmitted in each SSB burst associated with transitory SSB burst set 1024, an SSB transmission power for transmitted SSBs associated with transitory SSB burst set 1024, and a start time and duration of a measurement window associated with transmitted SSBs associated with transitory SSB burst set 1024. Similarly, transitory SSB burst set 1026 may be associated with a second set of values for one or more of a frequency associated with transitory SSB burst set 1026, an SCS associated with transitory SSB burst set 1026, a number of SSB bursts associated with transitory SSB burst set 1026, a periodicity or time gap associated with adjacent SSB bursts or transmitted SSBs associated with transitory SSB burst set 1026, a location of SSBs transmitted in each SSB burst associated with transitory SSB burst set 1026, an SSB transmission power for transmitted SSBs associated with transitory SSB burst set 1026, and a start time and duration of a measurement window associated with transmitted SSBs associated with transitory SSB burst set 1026.

Based on the measurements made at 1022 of the transitory SSB burst set 1024 and/or the transitory SSB burst set 1026, the first SCell 1005 and the second SCell 1007 may be activated (may transition from the transition ‘state’ during transition period 1021 to an activated state during an activated period 1027). During the activated period 1027, the first SCell 1005 may transmit, and the UE 1004 may receive, periodic SSBs 1028 (e.g., periodic SSB bursts) with a period that is different from the period associated with the transitory SSB burst set 1024. Similarly, during the activated period 1027, the second SCell 1007 may transmit, and the UE 1004 may receive, periodic SSBs 1030 (e.g., periodic SSB bursts) with a period that is different from the period associated with the transitory SSB burst set 1026. In some aspects, the periodic SSBs 1028 (or the periodic SSBs 1030) may “inherit” characteristics from the transitory SSB burst set 1024 (or the transitory SSB burst set 1026) such as a frequency, an SCS, a location of SSBs transmitted in each periodic SSB burst, or an SSB transmission power, while other characteristics may be different from the characteristics of the transitory SSB burst set 1024 (or transitory SSB burst set 1026), but, in some aspects, may be based on the related characteristics.

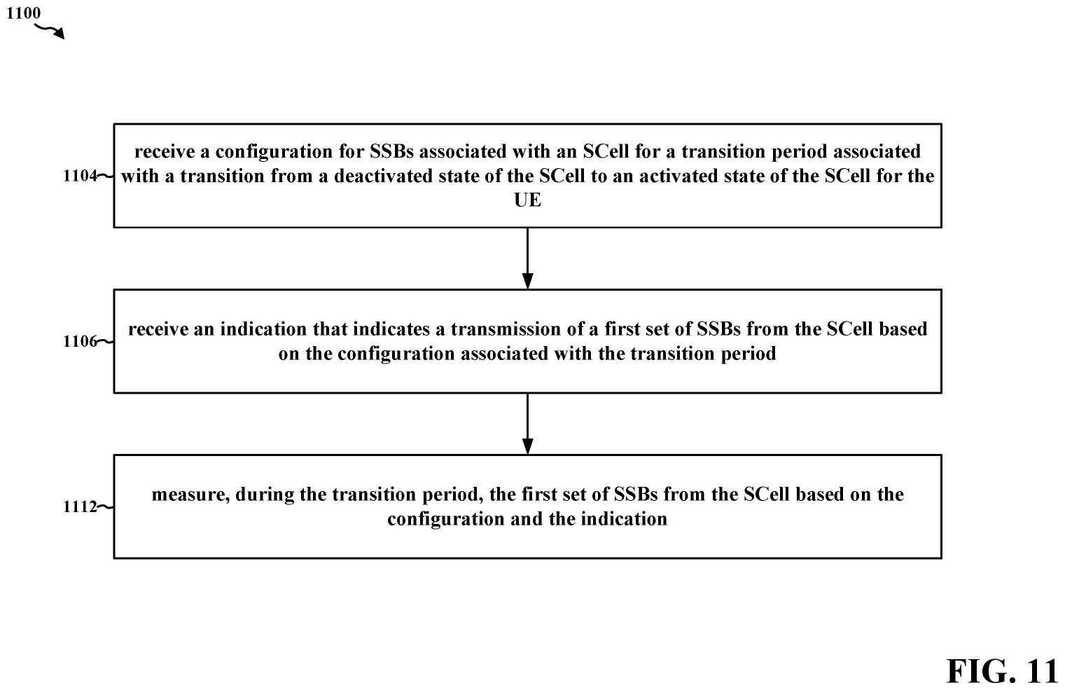

FIG. 11 is a flowchart 1100 of a method of wireless communication. The method may be performed by a wireless device such as a UE (e.g., the UE 104, 1004; the apparatus 1504). In some aspects, the UE may transmit a capability indication indicating support for an indication of a transmission of a first set of SSBs from an SCell based on a configuration associated with the transition period. The capability indication, in some aspects, may indicate a capability to support a transitory SSB burst set during a transition period associated with a transition from a deactivated state of the SCell to an activated state of the SCell for the UE. In some aspects, the capability indication may indicate support for DCI-based overwriting of a configuration for a set of SSBs received via a MCA-CE. For example, referring to FIG. 10, the UE 1004 may transmit, and the network 1002 (via the Cell 1003) may obtain and/or receive, UE capability indication 1010.

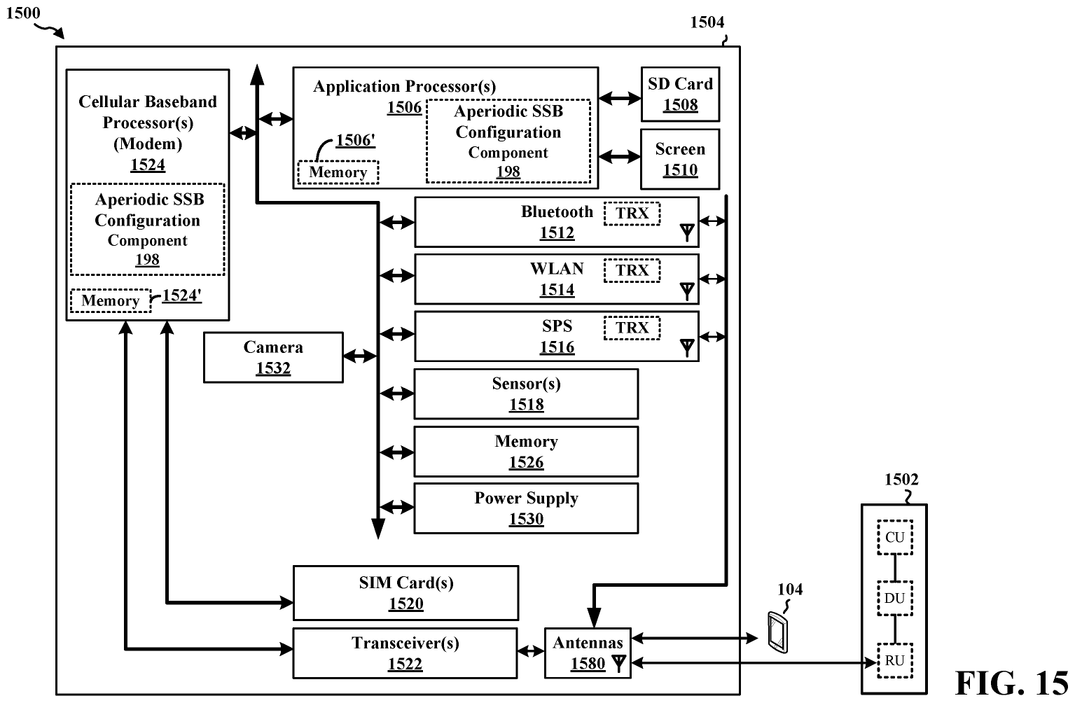

At 1104, the UE may receive a configuration for SSBs associated with an SCell for a transition period associated with a transition from a deactivated state of the SCell to an activated state of the SCell for the UE. For example, 1104 may be performed by application processor(s) 1506, cellular baseband processor(s) 1524, transceiver(s) 1522, antenna(s) 1580, and/or aperiodic SSB configuration component 198 of FIG. 15. In some aspects, the configuration for the SSBs is a first configuration of a plurality of configurations received by the UE and associated with SSBs for a transition period associated with a transition from a deactivated state of at least the SCell to an activated state of at least the SCell for the UE. The plurality of configurations received by the UE, in some aspects, may include configurations associated with (periodic) SSBs for an activated state of at least the SCell. The configurations, in some aspects, may be an indexed and/or addressable set of configurations that may be identified in association with an SCell activation for one or more activated SCells. The configurations, in some aspects, may be received via RRC or may be a known set of configurations. For example, referring to FIG. 10, the UE 1004 may receive, and the network 1002 (via the Cell 1003, e.g., a cell provided by a DU) may output and/or transmit, candidate SSB configurations 1012.

In some aspects, a configuration for SSBs for a transition period associated with a transition from a deactivated state of at least the SCell to an activated state of at least the SCell for the UE may indicate one or more of a frequency associated with transmitted SSBs associated with the configuration, an SCS associated with transmitted SSBs associated with the configuration, a number of SSB bursts associated with the configuration, a periodicity or time gap associated with adjacent SSB bursts or transmitted SSBs associated with the configuration, a location of SSBs transmitted in each SSB burst associated with the configuration (e.g., a bitmap indicating candidate SSB occasions locations for which an SSB will be transmitted), an SSB transmission power for transmitted SSBs associated with the configuration, and a start time and duration of a measurement window associated with transmitted SSBs associated with the configuration. Similarly, a configuration for (periodic) SSBs for an activated state of at least the SCell may indicate a frequency associated with the (periodic) SSBs; a subcarrier spacing associated with the (periodic) SSBs; a periodicity or time gap associated with adjacent periodic SSB bursts of the (periodic) SSBs; a location of SSBs transmitted in each SSB burst of the (periodic) SSBs; an SSB transmission power associated with the (periodic) SSBs; and a start time and duration of a measurement window associated with the (periodic) SSBs. In some aspects, at least a periodicity associated with the (periodic) SSBs may be larger than a periodicity associated with a configuration for SSBs for a transition period.

At 1106 the UE may receive an indication that indicates a transmission of a first set of SSBs from the SCell based on the configuration associated with the transition period. In some aspects, the indication may be received at 1106 via a MAC-CE (e.g., one of an enhanced SCell activation/deactivation MAC-CE or a configuration MAC-CE associated with an SCell activation/deactivation MAC-CE) or via DCI (e.g., a configuration DCI). Receiving the indication at 1106, in some aspects, may include receiving, via a MAC-CE, a first indication that indicates a transmission of a second set of SSBs from the SCell based on a second configuration of the plurality of configurations associated with the transition period and receiving, via DCI and after receiving the first indication, a second indication that indicates the transmission of a first set of SSBs from the SCell based on the configuration associated with the transition period, where the second indication overrides (e.g., overwrites or supersedes) the first indication. For example, 1106 may be performed by application processor(s) 1506, cellular baseband processor(s) 1524, transceiver(s) 1522, antenna(s) 1580, and/or aperiodic SSB configuration component 198 of FIG. 15. In some aspects, the indication (or the first and second indications) may be received from a network via one of a PCell, a PSCell, or an activated SCell. In some aspects, the indication may include a first set of bits used to indicate whether each of a set of SCells is activated or deactivated and a second set of bits used to indicate a set of configurations for the SSBs corresponding to a subset of the set of SCells indicated to be activated by the first set of bits. For example, referring to FIG. 10, the UE 1004 may receive, and the network 1002 (via the Cell 1003) may output and/or transmit, messages 1018 and 1020 indicating a transmission of transitory SSB burst set 1024, transitory SSB burst set 1026, periodic SSBs 1028, and/or periodic SSBs 1030. For example, a DU may transmit the messages 1018 and 1020.

The indication, in some aspects, may further indicate an additional transmission of at least one additional set of SSBs from at least one additional SCell. In some aspects, the indication may also indicate a transmission of a second set of periodic SSB bursts from the SCell for a time period associated with an activated state of the SCell, where the second set of periodic SSB bursts may be associated with a second configuration indicating at least one of: a frequency associated with the set of periodic SSB bursts; a subcarrier spacing associated with the set of periodic SSB bursts; a periodicity or time gap associated with adjacent periodic SSB bursts in the set of periodic SSB bursts; a location of SSBs transmitted in each SSB burst in the set of periodic SSB bursts; an SSB transmission power; and a start time and duration of a measurement window associated with the set of periodic SSB bursts. In some aspects, at least a periodicity associated with the second set of periodic SSB bursts is larger than a periodicity associated with the first set of SSBs.

A DCI including the indication, in some aspects, may be one of a UE-specific DCI or a UE-group common DCI. In some aspects, receiving the indication at 1106 may include monitoring for a (configuration) DCI or associated PDCCH transmission during a non-active time period associated with an activated DTX/DRX mode of operation at the UE (e.g., the UE may operate in a connected mode DRX (C-DRX) mode during which the UE (generally) omits monitoring for DCI when non-active (or during non-active time periods) and, if the DCI is scheduled during the non-active time period the UE monitors for a PDCCH carrying the DCI to receive the indication at 1106).

In some aspects, the UE may receive a second indication activating the SCell for the UE. In some aspects, the second indication activating the SCell of the UE and the (first) indication indicating the transmission of the first set of SSBs from the SCell based on the configuration associated with the transition period may be received in a same MAC-CE (e.g., the enhanced SCell activation/deactivation MAC-CE), in separate/different MAC-CEs, or in a MAC-CE and DCI, respectively. In some aspects, the first indication and the second indication may be received in a same PDSCH transmission or different PDSCH transmissions. In some aspects, the first indication may be received before the second indication while, in other aspects, the second indication may be received before the first indication. For example, referring to FIG. 10, the UE 1004 may receive, and the network 1002 (via the Cell 1003) may output and/or transmit, messages 1018 and 1020 indicating an activation of the first SCell 1005 and/or the second SCell 1007.

Finally, at 1112, the UE may measure, during the transition period, the first set of SSBs from the SCell based on the configuration and the indication. For example, 1112 may be performed by application processor(s) 1506, cellular baseband processor(s) 1524, transceiver(s) 1522, antenna(s) 1580, and/or aperiodic SSB configuration component 198 of FIG. 15. Referring, for example, to FIG. 10, the UE 1004 may measure at 1022, and the network 1002 (via the first SCell 1005 and/or the second SCell 1007) may output and/or transmit, transitory SSB burst set 1024 and/or transitory SSB burst set 1026.

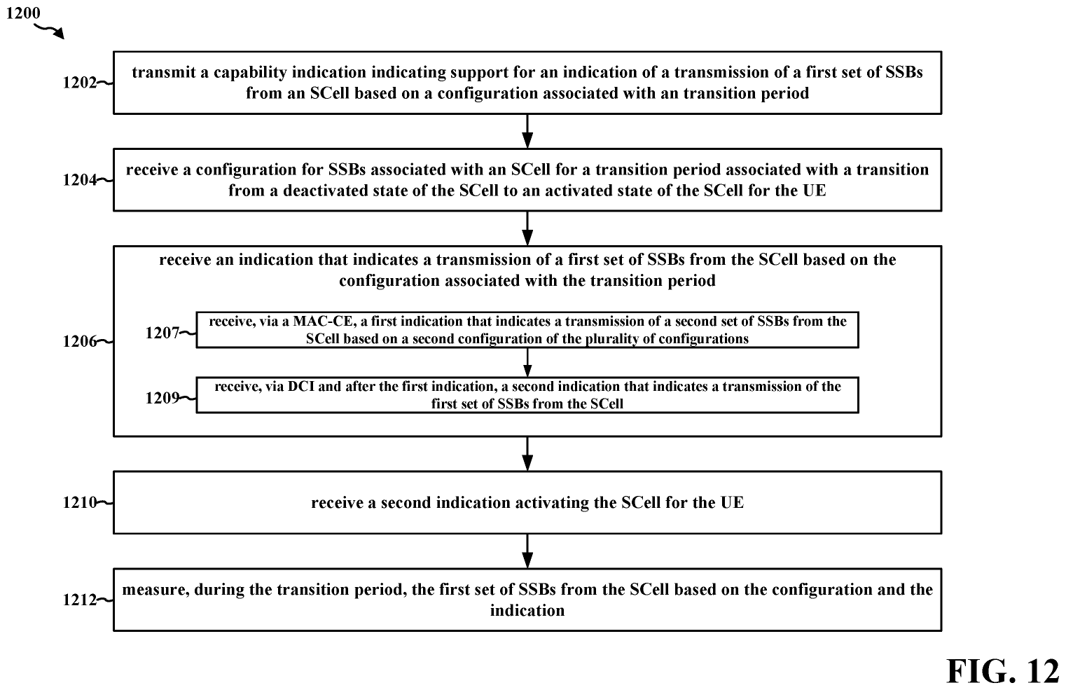

FIG. 12 is a flowchart 1200 of a method of wireless communication. The method may be performed by a wireless device such as a UE (e.g., the UE 104, 1004; the apparatus 1504). At 1202, the UE may transmit a capability indication indicating support for an indication of a transmission of a first set of SSBs from an SCell based on a configuration associated with the transition period. For example, 1202 may be performed by application processor(s) 1506, cellular baseband processor(s) 1524, transceiver(s) 1522, antenna(s) 1580, and/or aperiodic SSB configuration component 198 of FIG. 15. The capability indication, in some aspects, may indicate a capability to support a transitory SSB burst set during a transition period associated with a transition from a deactivated state of the SCell to an activated state of the SCell for the UE. In some aspects, the capability indication may indicate support for DCI-based overwriting of a configuration for a set of SSBs received via a MCA-CE. For example, referring to FIG. 10, the UE 1004 may transmit, and the network 1002 (via the Cell 1003) may obtain and/or receive, UE capability indication 1010.

At 1204, the UE may receive a configuration for SSBs associated with an SCell for a transition period associated with a transition from a deactivated state of the SCell to an activated state of the SCell for the UE. For example, 1204 may be performed by application processor(s) 1506, cellular baseband processor(s) 1524, transceiver(s) 1522, antenna(s) 1580, and/or aperiodic SSB configuration component 198 of FIG. 15. In some aspects, the configuration for the SSBs is a first configuration of a plurality of configurations received by the UE and associated with SSBs for a transition period associated with a transition from a deactivated state of at least the SCell to an activated state of at least the SCell for the UE. The plurality of configurations received by the UE, in some aspects, may include configurations associated with (periodic) SSBs for an activated state of at least the SCell. The configurations, in some aspects, may be an indexed and/or addressable set of configurations that may be identified in association with an SCell activation for one or more activated SCells. The configurations, in some aspects, may be received via RRC or may be a known set of configurations. For example, referring to FIG. 10, the UE 1004 may receive, and the network 1002 (via the Cell 1003) may output and/or transmit, candidate SSB configurations 1012.

In some aspects, a configuration for SSBs for a transition period associated with a transition from a deactivated state of at least the SCell to an activated state of at least the SCell for the UE may indicate one or more of a frequency associated with transmitted SSBs associated with the configuration, an SCS associated with transmitted SSBs associated with the configuration, a number of SSB bursts associated with the configuration, a periodicity or time gap associated with adjacent SSB bursts or transmitted SSBs associated with the configuration, a location of SSBs transmitted in each SSB burst associated with the configuration (e.g., a bitmap indicating candidate SSB occasions locations for which an SSB will be transmitted), an SSB transmission power for transmitted SSBs associated with the configuration, and a start time and duration of a measurement window associated with transmitted SSBs associated with the configuration. Similarly, a configuration for (periodic) SSBs for an activated state of at least the SCell may indicate a frequency associated with the (periodic) SSBs; a subcarrier spacing associated with the (periodic) SSBs; a periodicity or time gap associated with adjacent periodic SSB bursts of the (periodic) SSBs; a location of SSBs transmitted in each SSB burst of the (periodic) SSBs; an SSB transmission power associated with the (periodic) SSBs; and a start time and duration of a measurement window associated with the (periodic) SSBs. In some aspects, at least a periodicity associated with the (periodic) SSBs may be larger than a periodicity associated with a configuration for SSBs for a transition period.

At 1206 the UE may receive an indication that indicates a transmission of a first set of SSBs from the SCell based on the configuration associated with the transition period. In some aspects, the indication may be received at 1206 via a MAC-CE (e.g., one of an enhanced SCell activation/deactivation MAC-CE or a configuration MAC-CE associated with an SCell activation/deactivation MAC-CE) or via DCI (e.g., a configuration DCI). Receiving the indication at 1206, in some aspects, may include receiving, via a MAC-CE, a first indication that indicates a transmission of a second set of SSBs from the SCell based on a second configuration of the plurality of configurations associated with the transition period at 1207 and receiving, via DCI and after receiving the first indication at 1207, a second indication at 1209 that indicates the transmission of a first set of SSBs from the SCell based on the configuration associated with the transition period, where the second indication overrides (e.g., overwrites or supersedes) the first indication. For example, 1206, 1207, and 1209 may be performed by application processor(s) 1506, cellular baseband processor(s) 1524, transceiver(s) 1522, antenna(s) 1580, and/or aperiodic SSB configuration component 198 of FIG. 15. In some aspects, the indication (or the first and second indications) may be received from a network via one of a PCell, a PSCell, or an activated SCell. In some aspects, the indication may include a first set of bits used to indicate whether each of a set of SCells is activated or deactivated and a second set of bits used to indicate a set of configurations for the SSBs corresponding to a subset of the set of SCells indicated to be activated by the first set of bits. For example, referring to FIG. 10, the UE 1004 may receive, and the network 1002 (via the Cell 1003) may output and/or transmit, messages 1018 and 1020 indicating a transmission of transitory SSB burst set 1024, transitory SSB burst set 1026, periodic SSBs 1028, and/or periodic SSBs 1030.

The indication, in some aspects, may further indicate an additional transmission of at least one additional set of SSBs from at least one additional SCell. In some aspects, the indication may also indicate a transmission of a second set of periodic SSB bursts from the SCell for a time period associated with an activated state of the SCell, where the second set of periodic SSB bursts may be associated with a second configuration indicating at least one of: a frequency associated with the set of periodic SSB bursts; a subcarrier spacing associated with the set of periodic SSB bursts; a periodicity or time gap associated with adjacent periodic SSB bursts in the set of periodic SSB bursts; a location of SSBs transmitted in each SSB burst in the set of periodic SSB bursts; an SSB transmission power; and a start time and duration of a measurement window associated with the set of periodic SSB bursts. In some aspects, at least a periodicity associated with the second set of periodic SSB bursts is larger than a periodicity associated with the first set of SSBs.

A DCI including the indication, in some aspects, may be one of a UE-specific DCI or a UE-group common DCI. In some aspects, receiving the indication at 1206 may include monitoring for a (configuration) DCI or associated PDCCH transmission during a non-active time period associated with an activated DTX/DRX mode of operation at the UE (e.g., the UE may operate in a C-DRX mode during which the UE (generally) omits monitoring for DCI when non-active (or during non-active time periods) and, if the DCI is scheduled during the non-active time period the UE monitors for a PDCCH carrying the DCI during the non-active time period of the C-DRX mode to receive the indication at 1206).

At 1210, the UE may receive a second indication activating the SCell for the UE. For example, 1210 may be performed by application processor(s) 1506, cellular baseband processor(s) 1524, transceiver(s) 1522, antenna(s) 1580, and/or aperiodic SSB configuration component 198 of FIG. 15. In some aspects, the second indication activating the SCell of the UE and the (first) indication indicating the transmission of the first set of SSBs from the SCell based on the configuration associated with the transition period may be received in a same MAC-CE (e.g., the enhanced SCell activation/deactivation MAC-CE), in separate/different MAC-CEs, or in a MAC-CE and DCI, respectively. In some aspects, the first indication and the second indication may be received in a same PDSCH transmission or different PDSCH transmissions. In some aspects, the first indication may be received before the second indication while, in other aspects, the second indication may be received before the first indication. For example, referring to FIG. 10, the UE 1004 may receive, and the network 1002 (via the Cell 1003) may output and/or transmit, messages 1018 and 1020 indicating an activation of the first SCell 1005 and/or the second SCell 1007.

Finally, at 1212, the UE may measure, during the transition period, the first set of SSBs from the SCell based on the configuration and the indication. For example, 1212 may be performed by application processor(s) 1506, cellular baseband processor(s) 1524, transceiver(s) 1522, antenna(s) 1580, and/or aperiodic SSB configuration component 198 of FIG. 15. Referring, for example, to FIG. 10, the UE 1004 may measure at 1022, and the network 1002 (via the first SCell 1005 and/or the second SCell 1007) may output and/or transmit, transitory SSB burst set 1024 and/or transitory SSB burst set 1026.

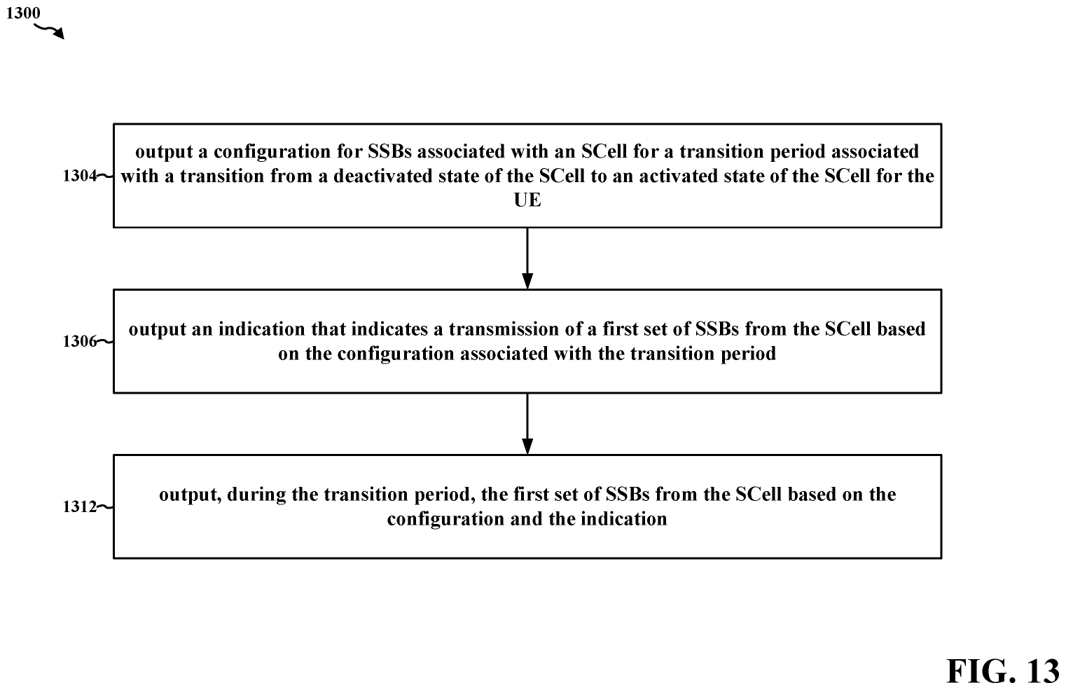

FIG. 13 is a flowchart 1300 of a method of wireless communication. The method may be performed by a network or one or more network components (e.g., the base station 102; the network 1002; the Cell 1003, the first SCell 1005, and the second SCell 1007; the network entity 1502, 1602, 1760). In some aspects, the network may obtain, from a wireless device (e.g., a UE), a capability indication indicating support for an indication of a transmission of a first set of SSBs from an SCell based on a configuration associated with the transition period. The capability indication, in some aspects, may indicate a capability to support a transitory SSB burst set during a transition period associated with a transition from a deactivated state of the SCell to an activated state of the SCell for the UE. In some aspects, the capability indication may indicate support for DCI-based overwriting of a configuration for a set of SSBs received via a MCA-CE. For example, referring to FIG. 10, the UE 1004 may transmit, and the network 1002 (via the Cell 1003) may obtain and/or receive, UE capability indication 1010.

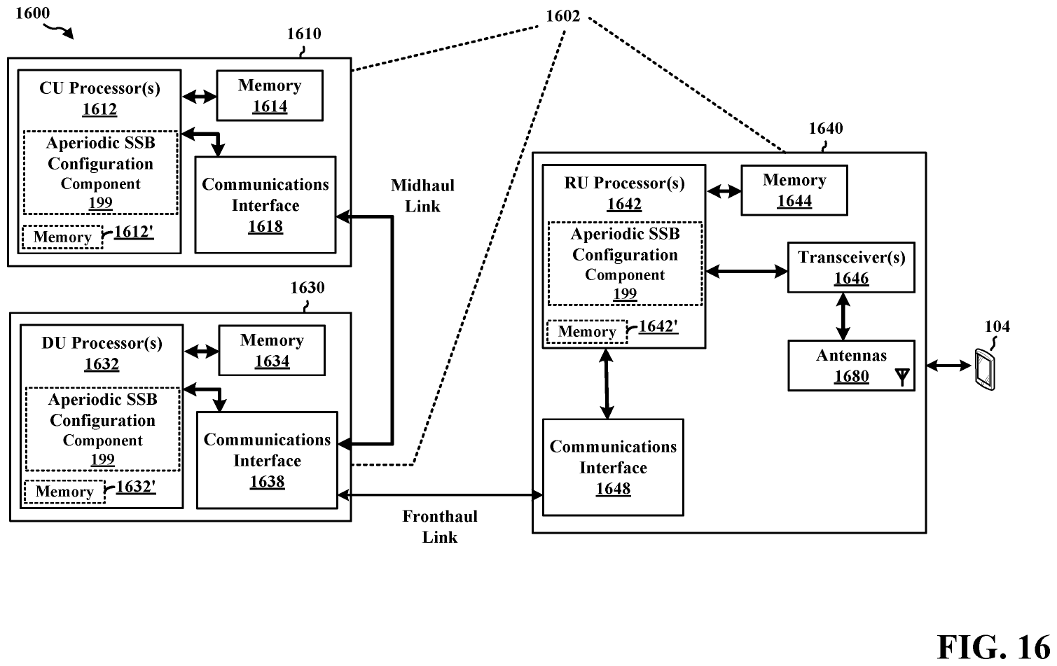

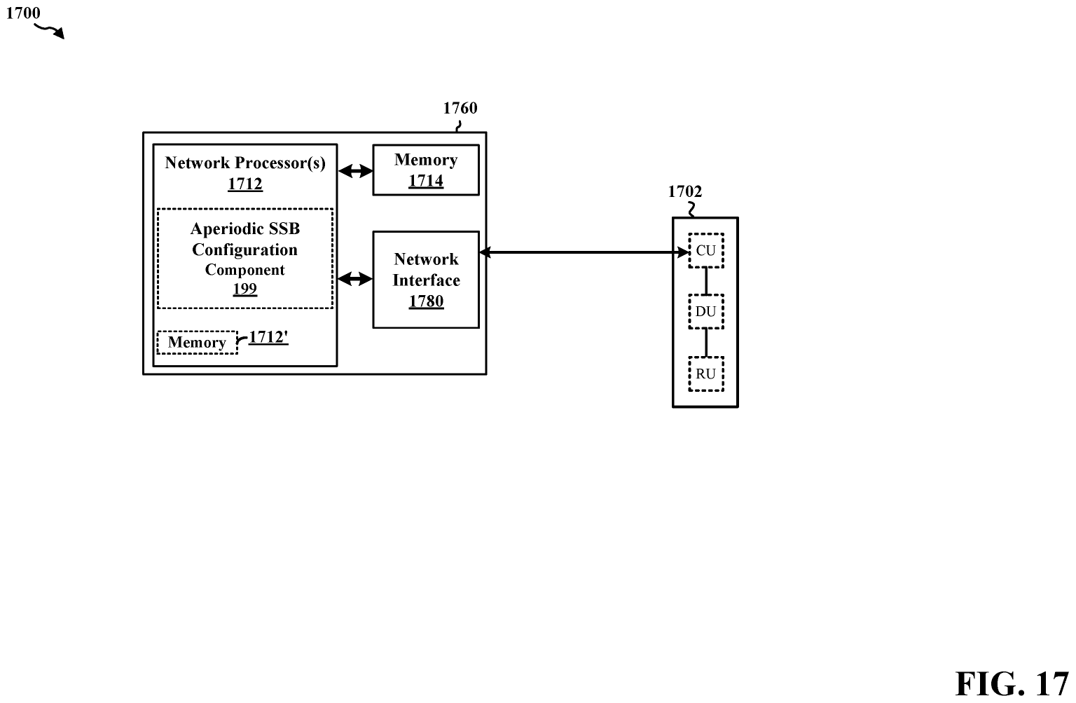

At 1304, the network may output a configuration for SSBs associated with an SCell for a transition period associated with a transition from a deactivated state of the SCell to an activated state of the SCell for the UE. For example, 1304 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. In some aspects, the configuration for the SSBs is a first configuration of a plurality of configurations received by the UE and associated with SSBs for a transition period associated with a transition from a deactivated state of at least the SCell to an activated state of at least the SCell for the UE. The plurality of configurations output by the network (and received by the UE), in some aspects, may include configurations associated with (periodic) SSBs for an activated state of at least the SCell. The configurations, in some aspects, may be an indexed and/or addressable set of configurations that may be identified in association with an SCell activation for one or more activated SCells. The configurations, in some aspects, may be output via RRC. For example, referring to FIG. 10, the UE 1004 may receive, and the network 1002 (via the Cell 1003) may output and/or transmit, candidate SSB configurations 1012.

In some aspects, a configuration for SSBs for a transition period associated with a transition from a deactivated state of at least the SCell to an activated state of at least the SCell for the UE may indicate one or more of a frequency associated with transmitted SSBs associated with the configuration, an SCS associated with transmitted SSBs associated with the configuration, a number of SSB bursts associated with the configuration, a periodicity or time gap associated with adjacent SSB bursts or transmitted SSBs associated with the configuration, a location of SSBs transmitted in each SSB burst associated with the configuration (e.g., a bitmap indicating candidate SSB occasions locations for which an SSB will be transmitted), an SSB transmission power for transmitted SSBs associated with the configuration, and a start time and duration of a measurement window associated with transmitted SSBs associated with the configuration. Similarly, a configuration for (periodic) SSBs for an activated state of at least the SCell may indicate a frequency associated with the (periodic) SSBs; a subcarrier spacing associated with the (periodic) SSBs; a periodicity or time gap associated with adjacent periodic SSB bursts of the (periodic) SSBs; a location of SSBs transmitted in each SSB burst of the (periodic) SSBs; an SSB transmission power associated with the (periodic) SSBs; and a start time and duration of a measurement window associated with the (periodic) SSBs. In some aspects, at least a periodicity associated with the (periodic) SSBs may be larger than a periodicity associated with a configuration for SSBs for a transition period.

At 1306 the network may output an indication that indicates a transmission of a first set of SSBs from the SCell based on the configuration associated with the transition period. In some aspects, the indication may be output at 1306 via a MAC-CE (e.g., one of an enhanced SCell activation/deactivation MAC-CE or a configuration MAC-CE associated with an SCell activation/deactivation MAC-CE) or via DCI (e.g., a configuration DCI). Outputting the indication at 1306, in some aspects, may include outputting, via a MAC-CE, a first indication that indicates a transmission of a second set of SSBs from the SCell based on a second configuration of the plurality of configurations associated with the transition period and outputting, via DCI and after receiving the first indication, a second indication that indicates the transmission of a first set of SSBs from the SCell based on the configuration associated with the transition period, where the second indication overrides (e.g., overwrites or supersedes) the first indication. For example, 1306 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. In some aspects, the indication (or the first and second indications) may be output from the network via one of a PCell, a PSCell, or an activated SCell. In some aspects, the indication may include a first set of bits used to indicate whether each of a set of SCells is activated or deactivated and a second set of bits used to indicate a set of configurations for the SSBs corresponding to a subset of the set of SCells indicated to be activated by the first set of bits. For example, referring to FIG. 10, the UE 1004 may receive, and the network 1002 (via the Cell 1003) may output and/or transmit, messages 1018 and 1020 indicating a transmission of transitory SSB burst set 1024, transitory SSB burst set 1026, periodic SSBs 1028, and/or periodic SSBs 1030.

The indication, in some aspects, may further indicate an additional transmission of at least one additional set of SSBs from at least one additional SCell. In some aspects, the indication may also indicate a transmission of a second set of periodic SSB bursts from the SCell for a time period associated with an activated state of the SCell, where the second set of periodic SSB bursts may be associated with a second configuration indicating at least one of: a frequency associated with the set of periodic SSB bursts; a subcarrier spacing associated with the set of periodic SSB bursts; a periodicity or time gap associated with adjacent periodic SSB bursts in the set of periodic SSB bursts; a location of SSBs transmitted in each SSB burst in the set of periodic SSB bursts; an SSB transmission power; and a start time and duration of a measurement window associated with the set of periodic SSB bursts. In some aspects, at least a periodicity associated with the second set of periodic SSB bursts is larger than a periodicity associated with the first set of SSBs.

A DCI including the indication, in some aspects, may be one of a UE-specific DCI or a UE-group common DCI. In some aspects, outputting the indication at 1306 may include outputting the (configuration) DCI via a PDCCH transmission during a non-active time period associated with an activated DTX/DRX mode of operation at the UE and the may be configured to monitor for the (configuration) DCI and/or the PDCCH transmission in the non-active state (e.g., the UE may operate in a C-DRX mode during which the UE (generally) omits monitoring for DCI when non-active (or during non-active time periods) and, if the DCI is scheduled during the non-active time period the UE may monitor for a PDCCH carrying the DCI to receive the indication output at 1306). In some aspects, the network may configure the behavior of the UE relating to monitoring for the DCI and/or PDCCH transmission during a non-active time period or state.

In some aspects, the network may output a second indication activating the SCell for the UE. In some aspects, the second indication activating the SCell of the UE and the (first) indication indicating the transmission of the first set of SSBs from the SCell based on the configuration associated with the transition period may be output in a same MAC-CE (e.g., the enhanced SCell activation/deactivation MAC-CE), in separate/different MAC-CEs, or in a MAC-CE and DCI, respectively. In some aspects, the first indication and the second indication may be output in a same PDSCH transmission or different PDSCH transmissions. In some aspects, the first indication may be output before the second indication while, in other aspects, the second indication may be output before the first indication. For example, referring to FIG. 10, the UE 1004 may receive, and the network 1002 (via the Cell 1003) may output and/or transmit, messages 1018 and 1020 indicating an activation of the first SCell 1005 and/or the second SCell 1007.

Finally, at 1312, the network may output, during the transition period, the first set of SSBs from the SCell based on the configuration and the indication. For example, 1312 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. Referring, for example, to FIG. 10, the UE 1004 may measure at 1022, and the network 1002 (via the first SCell 1005 and/or the second SCell 1007) may output and/or transmit, transitory SSB burst set 1024 and/or transitory SSB burst set 1026.

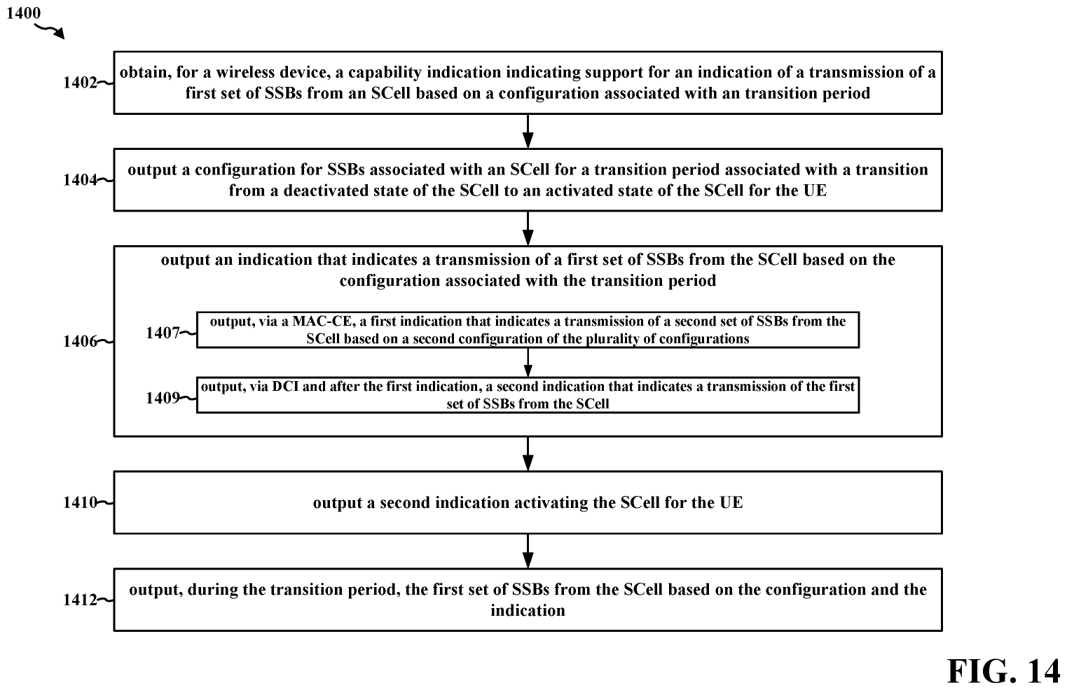

FIG. 14 is a flowchart 1400 of a method of wireless communication. The method may be performed by a network or one or more network components (e.g., the base station 102; the network 1002; the Cell 1003, the first SCell 1005, and the second SCell 1007; the network entity 1502, 1602, 1760). At 1402, the network may obtain, from a wireless device (e.g., a UE), a capability indication indicating support for an indication of a transmission of a first set of SSBs from an SCell based on a configuration associated with the transition period. For example, 1402 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. The capability indication, in some aspects, may indicate a capability to support a transitory SSB burst set during a transition period associated with a transition from a deactivated state of the SCell to an activated state of the SCell for the UE. In some aspects, the capability indication may indicate support for DCI-based overwriting of a configuration for a set of SSBs received via a MCA-CE. For example, referring to FIG. 10, the UE 1004 may transmit, and the network 1002 (via the Cell 1003) may obtain and/or receive, UE capability indication 1010.

At 1404, the network may output a configuration for SSBs associated with an SCell for a transition period associated with a transition from a deactivated state of the SCell to an activated state of the SCell for the UE. For example, 1404 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. In some aspects, the configuration for the SSBs is a first configuration of a plurality of configurations received by the UE and associated with SSBs for a transition period associated with a transition from a deactivated state of at least the SCell to an activated state of at least the SCell for the UE. The plurality of configurations output by the network (and received by the UE), in some aspects, may include configurations associated with (periodic) SSBs for an activated state of at least the SCell. The configurations, in some aspects, may be an indexed and/or addressable set of configurations that may be identified in association with an SCell activation for one or more activated SCells. The configurations, in some aspects, may be output via RRC. For example, referring to FIG. 10, the UE 1004 may receive, and the network 1002 (via the Cell 1003) may output and/or transmit, candidate SSB configurations 1012.

In some aspects, a configuration for SSBs for a transition period associated with a transition from a deactivated state of at least the SCell to an activated state of at least the SCell for the UE may indicate one or more of a frequency associated with transmitted SSBs associated with the configuration, an SCS associated with transmitted SSBs associated with the configuration, a number of SSB bursts associated with the configuration, a periodicity or time gap associated with adjacent SSB bursts or transmitted SSBs associated with the configuration, a location of SSBs transmitted in each SSB burst associated with the configuration (e.g., a bitmap indicating candidate SSB occasions locations for which an SSB will be transmitted), an SSB transmission power for transmitted SSBs associated with the configuration, and a start time and duration of a measurement window associated with transmitted SSBs associated with the configuration. Similarly, a configuration for (periodic) SSBs for an activated state of at least the SCell may indicate a frequency associated with the (periodic) SSBs; a subcarrier spacing associated with the (periodic) SSBs; a periodicity or time gap associated with adjacent periodic SSB bursts of the (periodic) SSBs; a location of SSBs transmitted in each SSB burst of the (periodic) SSBs; an SSB transmission power associated with the (periodic) SSBs; and a start time and duration of a measurement window associated with the (periodic) SSBs. In some aspects, at least a periodicity associated with the (periodic) SSBs may be larger than a periodicity associated with a configuration for SSBs for a transition period.

At 1406 the network may output an indication that indicates a transmission of a first set of SSBs from the SCell based on the configuration associated with the transition period. In some aspects, the indication may be output at 1406 via a MAC-CE (e.g., one of an enhanced SCell activation/deactivation MAC-CE or a configuration MAC-CE associated with an SCell activation/deactivation MAC-CE) or via DCI (e.g., a configuration DCI). Outputting the indication at 1406, in some aspects, may include outputting, via a MAC-CE, a first indication that indicates a transmission of a second set of SSBs from the SCell based on a second configuration of the plurality of configurations associated with the transition period at 1407 and outputting, via DCI and after receiving the first indication at 1407, a second indication at 1409 that indicates the transmission of a first set of SSBs from the SCell based on the configuration associated with the transition period, where the second indication overrides (e.g., overwrites or supersedes) the first indication. For example, 1406, 1407, and 1409 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. In some aspects, the indication (or the first and second indications) may be output from the network via one of a PCell, a PSCell, or an activated SCell. In some aspects, the indication may include a first set of bits used to indicate whether each of a set of SCells is activated or deactivated and a second set of bits used to indicate a set of configurations for the SSBs corresponding to a subset of the set of SCells indicated to be activated by the first set of bits. For example, referring to FIG. 10, the UE 1004 may receive, and the network 1002 (via the Cell 1003) may output and/or transmit, messages 1018 and 1020 indicating a transmission of transitory SSB burst set 1024, transitory SSB burst set 1026, periodic SSBs 1028, and/or periodic SSBs 1030.

The indication, in some aspects, may further indicate an additional transmission of at least one additional set of SSBs from at least one additional SCell. In some aspects, the indication may also indicate a transmission of a second set of periodic SSB bursts from the SCell for a time period associated with an activated state of the SCell, where the second set of periodic SSB bursts may be associated with a second configuration indicating at least one of: a frequency associated with the set of periodic SSB bursts; a subcarrier spacing associated with the set of periodic SSB bursts; a periodicity or time gap associated with adjacent periodic SSB bursts in the set of periodic SSB bursts; a location of SSBs transmitted in each SSB burst in the set of periodic SSB bursts; an SSB transmission power; and a start time and duration of a measurement window associated with the set of periodic SSB bursts. In some aspects, at least a periodicity associated with the second set of periodic SSB bursts is larger than a periodicity associated with the first set of SSBs.

A DCI including the indication, in some aspects, may be one of a UE-specific DCI or a UE-group common DCI. In some aspects, outputting the indication at 1406 may include outputting the (configuration) DCI via a PDCCH transmission during a non-active time period associated with an activated DTX/DRX mode of operation at the UE and the may be configured to monitor for the (configuration) DCI and/or the PDCCH transmission in the non-active state (e.g., the UE may operate in a C-DRX mode during which the UE (generally) omits monitoring for DCI when non-active (or during non-active time periods) and, if the DCI is scheduled during the non-active time period the UE may monitor for a PDCCH carrying the DCI to receive the indication output at 1406). In some aspects, the network may configure the behavior of the UE relating to monitoring for the DCI and/or PDCCH transmission during a non-active time period or state.

At 1410, the network may output a second indication activating the SCell for the UE. For example, 1410 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. In some aspects, the second indication activating the SCell of the UE and the (first) indication indicating the transmission of the first set of SSBs from the SCell based on the configuration associated with the transition period may be output in a same MAC-CE (e.g., the enhanced SCell activation/deactivation MAC-CE), in separate/different MAC-CEs, or in a MAC-CE and DCI, respectively. In some aspects, the first indication and the second indication may be output in a same PDSCH transmission or different PDSCH transmissions. In some aspects, the first indication may be output before the second indication while, in other aspects, the second indication may be output before the first indication. For example, referring to FIG. 10, the UE 1004 may receive, and the network 1002 (via the Cell 1003) may output and/or transmit, messages 1018 and 1020 indicating an activation of the first SCell 1005 and/or the second SCell 1007.

Finally, at 1412, the network may output, during the transition period, the first set of SSBs from the SCell based on the configuration and the indication. For example, 1412 may be performed by CU processor(s) 1612, DU processor(s) 1632, RU processor(s) 1642, transceiver(s) 1646, antenna(s) 1680, network processor 1712, network interface 1780, and/or aperiodic SSB configuration component 199 of FIGS. 16 and 17. Referring, for example, to FIG. 10, the UE 1004 may measure at 1022, and the network 1002 (via the first SCell 1005 and/or the second SCell 1007) may output and/or transmit, transitory SSB burst set 1024 and/or transitory SSB burst set 1026.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, a satellite positioning system module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the satellite positioning system module 1516 may include an on-chip transceiver (TRX) (or in some cases, just a receiver (RX)). The Bluetooth module 1512, the WLAN module 1514, and the satellite positioning system module 1516 may include their own dedicated antennas and/or utilize one or more antennas 1580 for communication. The cellular baseband processor(s) 1524 communicates through the transceiver(s) 1522 via the one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the aperiodic SSB configuration component 198 may be configured to receive a configuration for SSBs associated with an SCell for a transition period associated with a transition from a deactivated state of the SCell to an activated state of the SCell for the UE. The aperiodic SSB configuration component 198 may also be configured to receive an indication that indicates a transmission of a first set of SSBs from the SCell based on the configuration associated with the transition period and may measure, during the transition period, the first set of SSBs from the SCell based on the configuration and the indication. The aperiodic SSB configuration component 198 may be within the cellular baseband processor(s) 1524, the application processor(s) 1506, or both the cellular baseband processor(s) 1524 and the application processor(s) 1506. The aperiodic SSB configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a configuration for SSBs associated with an SCell for a transition period associated with a transition from a deactivated state of the SCell to an activated state of the SCell for the UE. The apparatus 1504, and in particular the cellular baseband processor(s) 1524 and/or the application processor(s) 1506, may include means for receiving an indication that indicates a transmission of a first set of SSBs from the SCell based on the configuration associated with the transition period. The apparatus 1504, and in particular the cellular baseband processor(s) 1524 and/or the application processor(s) 1506, may include means for measuring, during the transition period, the first set of SSBs from the SCell based on the configuration and the indication. The apparatus 1504, and in particular the cellular baseband processor(s) 1524 and/or the application processor(s) 1506, may include means for receiving a second indication activating the SCell for the UE. The apparatus 1504, and in particular the cellular baseband processor(s) 1524 and/or the application processor(s) 1506, may include means for receiving, via a MAC-CE, a first indication that indicates a transmission of a second set of SSBs from the SCell based on a second configuration of the plurality of configurations associated with the transition period. The apparatus 1504, and in particular the cellular baseband processor(s) 1524 and/or the application processor(s) 1506, may include means for receiving, via DCI after the first indication, the second indication. The apparatus 1504, and in particular the cellular baseband processor(s) 1524 and/or the application processor(s) 1506, may include means for monitoring for a physical downlink control channel (PDCCH) carrying the DCI during a non-active time period of the C-DRX mode. The apparatus 1504, and in particular the cellular baseband processor(s) 1524 and/or the application processor(s) 1506, may include means for transmitting a capability indication indicating support for the indication of the transmission of the first set of SSBs from the SCell based on the configuration associated with the transition period. The apparatus 1504 may further include means for performing any of the aspects described in connection with the flowcharts in FIG. 11 or 12, and/or performed by the UE in the communication flow of FIG. 10. The means may be the aperiodic SSB configuration component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means or as described in relation to FIGS. 11 and 12.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the aperiodic SSB configuration component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, one or more antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the aperiodic SSB configuration component 199 may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the aperiodic SSB configuration component 199 may be configured to output, during the transition period, the first set of SSBs from the SCell based on the configuration and the indication. The aperiodic SSB configuration component 199 may be within one or more processors of one or more of the CU 1610, DU 1630, and the RU 1640. The aperiodic SSB configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for outputting a configuration for SSBs associated with an SCell for a transition period associated with a transition from a deactivated state of the SCell and an activated state of the SCell for a UE. The network entity 1602 may include means for outputting an indication that indicates a transmission of a first set of SSBs from the SCell based on the configuration associated with the transition period. The network entity 1602 may include means for outputting, during the transition period, the first set of SSBs from the SCell based on the configuration and the indication. The network entity 1602 may include means for outputting a second indication activating the SCell for the UE. The network entity 1602 may include means for obtaining, for a wireless device, a capability indication indicating support for a capability for the indication of the transmission of the first set of SSBs from the SCell based on the configuration associated with the transition period. The network entity 1602 may include means for outputting, via a MAC-CE, a first indication that indicates a transmission of a second set of SSBs from the SCell based on a second configuration of the plurality of configurations associated with the transition period. The network entity 1602 may include means for outputting, via DCI and after the first indication, the second indication, wherein the second indication overrides the first indication. The network entity 1602 may further include means for performing any of the aspects described in connection with the flowcharts in FIG. 13 or 14, and/or performed by the network or cell in the communication flow of FIG. 10. The means may be the aperiodic SSB configuration component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 13 and 14.

FIG. 17 is a diagram 1700 illustrating an example of a hardware implementation for a network entity 1760. In one example, the network entity 1760 may be within the core network 120. The network entity 1760 may include at least one network processor 1712. The network processor(s) 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The network processor(s) 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the aperiodic SSB configuration component 199 may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the aperiodic SSB configuration component 199 may be configured to output, during the transition period, the first set of SSBs from the SCell based on the configuration and the indication. The aperiodic SSB configuration component 199 may be within the network processor(s) 1712. The aperiodic SSB configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1760 may include a variety of components configured for various functions. In one configuration, the network entity 1760 may include means for outputting a configuration for SSBs associated with an SCell for a transition period associated with a transition from a deactivated state of the SCell and an activated state of the SCell for a UE. The network entity 1760 may include means for outputting an indication that indicates a transmission of a first set of SSBs from the SCell based on the configuration associated with the transition period. The network entity 1760 may include means for outputting, during the transition period, the first set of SSBs from the SCell based on the configuration and the indication. The network entity 1760 may include means for outputting a second indication activating the SCell for the UE. The network entity 1760 may include means for obtaining, for a wireless device, a capability indication indicating support for a capability for the indication of the transmission of the first set of SSBs from the SCell based on the configuration associated with the transition period. The network entity 1760 may include means for outputting, via a MAC-CE, a first indication that indicates a transmission of a second set of SSBs from the SCell based on a second configuration of the plurality of configurations associated with the transition period. The network entity 1760 may include means for outputting, via DCI and after the first indication, the second indication, wherein the second indication overrides the first indication. The network entity 1760 may further include means for performing any of the aspects described in connection with the flowcharts in FIG. 13 or 14, and/or performed by the network or cell in the communication flow of FIG. 10. The means may be the aperiodic SSB configuration component 199 of the network entity 1760 configured to perform the functions recited by the means or as described in relation to FIGS. 13 and 14.

Various aspects relate generally to triggering and/or configuring a set of SSBs associated with a transition from a deactivated state of an SCell to an activated state of the SCell. Some aspects more specifically relate to indicating a configuration for SSBs during a transition state of an SCell that is different from a configuration of SSBs during an activated state of the SCell, where the SSBs may include one or more of periodic, aperiodic, or semi-persistent (e.g., the object of a semi-persistent scheduling) SSBs. In some examples, a UE may be configured to receive a configuration for SSBs associated with an SCell for a transition period associated with a transition from a deactivated state of the SCell to an activated state of the SCell for the UE. The UE may also may be configured to receive an indication that indicates a transmission of a first set of SSBs from the SCell based on the configuration associated with the transition period and may measure, during the transition period, the first set of SSBs from the SCell based on the configuration and the indication. In some aspects, a network (e.g., a PCell, a PSCell, or an activated SCell) may be configured to output a configuration for SSBs associated with an SCell for a transition period associated with a transition from a deactivated state of the SCell and an activated state of the SCell for a UE and to output an indication that indicates a transmission of a first set of SSBs from the SCell based on the configuration associated with the transition period. In some aspects, the network may be configured to output, during the transition period, the first set of SSBs from the SCell based on the configuration and the indication.

Particular aspects of the subject matter described in this disclosure can be implemented to realize one or more of the following potential advantages. In some examples, by triggering and/or configuring a set of SSBs associated with a transition from a deactivated state of an SCell to an activated state of the SCell, the described techniques can be used to reduce a latency associated with the transition and/or the activation of the SCell.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving a configuration for synchronization signal blocks (SSBs) associated with a secondary cell (SCell) for a transition period associated with a transition from a deactivated state of the SCell to an activated state of the SCell for the UE; receiving an indication that indicates a transmission of a first set of SSBs from the SCell based on the configuration associated with the transition period; and measuring, during the transition period, the first set of SSBs from the SCell based on the configuration and the indication.

Aspect 2 is the method of aspect 1, wherein the indication further indicates to activate the SCell for the UE and wherein the configuration for the SSBs is a first configuration of a plurality of configurations associated with SSBs for the transition period associated with the transition from the deactivated state of at least the SCell to the activated state of at least the SCell for the UE and the indication comprises a first set of bits used to indicate whether each of a set of SCells is activated or deactivated and a second set of bits used to indicate a set of configurations for the SSBs corresponding to a subset of the set of SCells indicated to be activated by the first set of bits.

Aspect 3 is the method of any of aspects 1 and 2, wherein the indication further indicates an additional transmission of at least one additional set of SSBs from at least one additional SCell.

Aspect 4 is the method of any of aspects 1 to 3, wherein the indication is received via one or more of a medium access control (MAC) control element (CE) (MAC-CE) or downlink control information (DCI).

Aspect 5 is the method of any of aspects 1 to 4, wherein the indication is a first indication, the method further comprising: receiving a second indication activating the SCell for the UE.

Aspect 6 is the method of aspect 5, wherein the first indication and the second indication are received in a same medium access control (MAC) control element (CE) (MAC-CE) or a same physical download shared channel (PDSCH) transmission.

Aspect 7 is the method of aspect 5, wherein the first indication is received in a different medium access control (MAC) control element (CE) (MAC-CE) or a different physical download shared channel (PDSCH) transmission than the second indication.

Aspect 8 is the method of any of aspects 1 to 7, wherein the configuration for the SSBs is a first configuration of a plurality of configurations associated with SSBs for the transition period associated with the transition from the deactivated state of at least the SCell to the activated state of at least the SCell for the UE and the indication is a second indication, and receiving the indication comprises: receiving, via a media access control (MAC) control element (CE) (MAC-CE), a first indication that indicates a second transmission of a second set of SSBs from the SCell based on a second configuration of the plurality of configurations associated with the transition period; and receiving, via downlink control information (DCI) after the first indication, the second indication, wherein the second indication overrides the first indication.

Aspect 9 is the method of aspect 8, wherein the DCI is one of a UE-specific DCI or a UE-group common DCI, and wherein at least one of the first indication and the second indication indicate an additional transmission of an additional set of SSBs from an additional SCell based on an additional configuration of the plurality of configurations associated with the transition period.

Aspect 10 is the method of any of aspects 8 and 9, wherein the UE operates in a connected mode discontinuous reception (C-DRX) mode, wherein the method further comprises monitoring for a physical downlink control channel (PDCCH) carrying the DCI during a non-active time period of the C-DRX mode.

Aspect 11 is the method of any of aspects 1 to 10, further comprising: transmitting a capability indication indicating support for the indication of the transmission of the first set of SSBs from the SCell based on the configuration associated with the transition period.

Aspect 12 is the method of any of aspects 1 to 11, wherein the first set of SSBs comprises a plurality of SSB bursts and the configuration indicates at least one of: a frequency associated with the plurality of SSB bursts; a subcarrier spacing associated with the plurality of SSB bursts; a number of SSB bursts in the plurality of SSB bursts; a periodicity or time gap associated with adjacent SSB bursts in the plurality of SSB bursts; a location of SSBs transmitted in each SSB burst in the plurality of SSB bursts; an SSB transmission power; and a start time and duration of a measurement window associated with the plurality of SSB bursts.

Aspect 13 is the method of any of aspects 1 to 12, wherein the indication is received from one of a primary cell (PCell), a primary SCell (PSCell), or an additional SCell.

Aspect 14 is the method of any of aspects 1 to 13, the indication further indicates a second transmission of a second set of periodic SSB bursts from the SCell for a time period associated with the activated state of the SCell, wherein the second set of periodic SSB bursts is associated with a second configuration indicating at least one of: a frequency associated with the second set of periodic SSB bursts; a subcarrier spacing associated with the second set of periodic SSB bursts; a periodicity or time gap associated with adjacent periodic SSB bursts in the second set of periodic SSB bursts; a location of SSBs transmitted in each SSB burst in the second set of periodic SSB bursts; an SSB transmission power; and a start time and duration of a measurement window associated with the second set of periodic SSB bursts, wherein at least a periodicity associated with the second set of periodic SSB bursts is larger than a first periodicity associated with the first set of SSBs.

Aspect 15 is a method of wireless communication at a network device, comprising: outputting a configuration for synchronization signal blocks (SSBs) associated with a secondary cell (SCell) for a transition period associated with a transition from a deactivated state of the SCell and an activated state of the SCell for a user equipment (UE); outputting an indication that indicates a transmission of a first set of SSBs from the SCell based on the configuration associated with the transition period; and outputting, during the transition period, the first set of SSBs from the SCell based on the configuration and the indication.

Aspect 16 is the method of aspect 15, wherein the indication further indicates to activate the SCell for the UE and wherein the configuration for the SSBs is a first configuration of a plurality of configurations associated with SSBs for the transition period associated with the transition from the deactivated state of at least the SCell to the activated state of at least the SCell for the UE and the indication comprises a first set of bits used to indicate whether each of a set of SCells is activated or deactivated and a second set of bits used to indicate a set of configurations for the SSBs corresponding to a subset of the set of SCells indicated to be activated by the first set of bits.

Aspect 17 is the method of any of aspects 15 and 16, wherein the indication further indicates an additional transmission of at least one additional set of SSBs from at least one additional SCell.

Aspect 18 is the method of any of aspects 15 to 17, wherein the indication is a first indication, the method further comprising: outputting a second indication activating the SCell for the UE.

Aspect 19 is the method of any of aspects 15 to 18, wherein outputting the indication comprises outputting the indication via one of a medium access control (MAC) control element (CE) (MAC-CE) or downlink control information (DCI).

Aspect 20 is the method of any of aspects 15 to 19, wherein the indication is a first indication, the method further comprising: outputting a second indication activating the SCell for the UE.

Aspect 21 is the method of aspect 20, wherein the first indication and the second indication are output in a same medium access control (MAC) control element (CE) (MAC-CE) or a same physical download shared channel (PDSCH) transmission.

Aspect 22 is the method of aspect 20, wherein the second indication is outut in a different medium access control (MAC) control element (CE) (MAC-CE) or a different physical download shared channel (PDSCH) transmission than the second indication.

Aspect 23 is the method of any of aspects 15 to 22, wherein the configuration for the SSBs is a first configuration of a plurality of configurations associated with SSBs for a transition period associated with a transition from a deactivated state of at least the SCell to an activated state of at least the SCell for the UE and the indication is a second indication, and outputting the indication comprises: outputting, via a media access control (MAC) control element (CE) (MAC-CE), a first indication that indicates a transmission of a second set of SSBs from the SCell based on a second configuration of the plurality of configurations associated with the transition period; and outputting, via downlink control information (DCI) after the first indication, the second indication, wherein the second indication overrides the first indication.

Aspect 24 is the method of aspect 23, wherein the DCI is one of a UE-specific DCI or a UE-group common DCI, and wherein at least one of the first indication and the second indication indicate a transmission of an additional set of SSBs from an additional SCell based on an additional configuration of the plurality of configurations associated with the transition period.

Aspect 25 is the method of any of aspects 15 to 24, further comprising: obtaining, from the UE, a capability indication indicating support for the indication of the transmission of the first set of SSBs from the SCell based on the configuration associated with the transition period.

Aspect 26 is the method of any of aspects 15 to 25, wherein the first set of SSBs comprises a plurality of SSB bursts and the configuration indicates at least one of: a frequency associated with the plurality of SSB bursts; a subcarrier spacing associated with the plurality of SSB bursts; a number of SSB bursts in the plurality of SSB bursts; a periodicity or time gap associated with adjacent SSB bursts in the plurality of SSB bursts; a location of SSBs transmitted in each SSB burst in the plurality of SSB bursts; an SSB transmission power; and a start time and duration of a measurement window associated with the plurality of SSB bursts.

Aspect 27 is the method of any of aspects 15 to 26, wherein the indication is output from one of a primary cell (PCell), a primary SCell (PSCell), or an additional SCell.

Aspect 28 is the method of any of aspects 15 to 27, wherein the indication further indicates a transmission of a second set of periodic SSB bursts from the SCell for a time period associated with an activated state of the SCell, wherein the second set of periodic SSB bursts is associated with a second configuration indicating at least one of: a frequency associated with the set of periodic SSB bursts; a subcarrier spacing associated with the set of periodic SSB bursts; a periodicity or time gap associated with adjacent periodic SSB bursts in the set of periodic SSB bursts; a location of SSBs transmitted in each SSB burst in the set of periodic SSB bursts; an SSB transmission power; and a start time and duration of a measurement window associated with the set of periodic SSB bursts, wherein at least a periodicity associated with the second set of periodic SSB bursts is larger than a periodicity associated with the first set of SSBs.

Aspect 29 is an apparatus for wireless communication at a device including a memory and at least one processor coupled to the memory and, based at least in part on information stored in the memory, the at least one processor is configured to implement any of aspects 1 to 14.

Aspect 30 is the apparatus of aspect 29, further including a transceiver or an antenna coupled to the at least one processor.

Aspect 31 is an apparatus for wireless communication at a device including means for implementing any of aspects 1 to 14.

Aspect 32 is a computer-readable medium (e.g., a non-transitory computer-readable medium) storing computer executable code, where the code when executed by a processor causes the processor to implement any of aspects 1 to 14.

Aspect 33 is an apparatus for wireless communication at a device including a memory and at least one processor coupled to the memory and, based at least in part on information stored in the memory, the at least one processor is configured to implement any of aspects 15 to 28.

Aspect 34 is the apparatus of aspect 33, further including a transceiver or an antenna coupled to the at least one processor.

Aspect 35 is an apparatus for wireless communication at a device including means for implementing any of aspects 15 to 28.

Aspect 36 is a computer-readable medium (e.g., a non-transitory computer-readable medium) storing computer executable code, where the code when executed by a processor causes the processor to implement any of aspects 15 to 28.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive a configuration for synchronization signal blocks (SSBs) associated with a secondary cell (SCell) for a transition period associated with a transition from a deactivated state of the SCell to an activated state of the SCell for the UE;
receive an indication that indicates a transmission of a first set of SSBs from the SCell based on the configuration associated with the transition period; and
measure, during the transition period, the first set of SSBs from the SCell based on the configuration and the indication.

2. The apparatus of claim 1, wherein the indication further indicates to activate the SCell for the UE and wherein the configuration for the SSBs is a first configuration of a plurality of configurations associated with SSBs for the transition period associated with the transition from the deactivated state of at least the SCell to the activated state of at least the SCell for the UE and the indication comprises a first set of bits used to indicate whether each of a set of SCells is activated or deactivated and a second set of bits used to indicate a set of configurations for the SSBs corresponding to a subset of the set of SCells indicated to be activated by the first set of bits.

3. The apparatus of claim 1, wherein the indication further indicates an additional transmission of at least one additional set of SSBs from at least one additional SCell.

4. The apparatus of claim 1, wherein to receive the indication, the at least one processor, individually or in any combination, is configured to receive the indication via one or more of a medium access control (MAC) control element (CE) (MAC-CE) or downlink control information (DCI).

5. The apparatus of claim 1, wherein the indication is a first indication, wherein the at least one processor, individually or in any combination, is further configured to:
receive a second indication activating the SCell for the UE.

6. The apparatus of claim 5, wherein to receive the first indication and the second indication, the at least one processor, individually or in any combination, is configured to receive the first indication and the second indication in a same medium access control (MAC) control element (CE) (MAC-CE) or a same physical download shared channel (PDSCH) transmission.

7. The apparatus of claim 5, wherein to receive the first indication and the second indication, the at least one processor, individually or in any combination, is configured to receive the first indication is received in a different medium access control (MAC) control element (CE) (MAC-CE) or a different physical download shared channel (PDSCH) transmission than the second indication.

8. The apparatus of claim 1, wherein the configuration for the SSBs is a first configuration of a plurality of configurations associated with SSBs for the transition period associated with the transition from the deactivated state of at least the SCell to the activated state of at least the SCell for the UE and the indication is a second indication, and to receive the indication, the at least one processor, individually or in any combination, is further configured to:
receive, via a media access control (MAC) control element (CE) (MAC-CE), a first indication that indicates a second transmission of a second set of SSBs from the SCell based on a second configuration of the plurality of configurations associated with the transition period; and
receive, via downlink control information (DCI) after the first indication, the second indication, wherein the second indication overrides the first indication.

9. The apparatus of claim 8, wherein the DCI is one of a UE-specific DCI or a UE-group common DCI, and wherein at least one of the first indication and the second indication indicate an additional transmission of an additional set of SSBs from an additional SCell based on an additional configuration of the plurality of configurations associated with the transition period.

10. The apparatus of claim 8, wherein the UE operates in a connected mode discontinuous reception (C-DRX) mode, wherein the at least one processor, individually or in any combination, is further configured to monitor for a physical downlink control channel (PDCCH) carrying the DCI during a non-active time period of the C-DRX mode.

11. The apparatus of claim 1, wherein the at least one processor, individually or in any combination, is further configured to:
transmit a capability indication indicating support for the indication of the transmission of the first set of SSBs from the SCell based on the configuration associated with the transition period.

12. The apparatus of claim 1, wherein the first set of SSBs comprises a plurality of SSB bursts and the configuration indicates at least one of:
a frequency associated with the plurality of SSB bursts;
a subcarrier spacing associated with the plurality of SSB bursts;
a number of SSB bursts in the plurality of SSB bursts;
a periodicity or time gap associated with adjacent SSB bursts in the plurality of SSB bursts;
a location of SSBs transmitted in each SSB burst in the plurality of SSB bursts;
an SSB transmission power; and
a start time and duration of a measurement window associated with the plurality of SSB bursts.

13. The apparatus of claim 1, wherein to receive the indication, the at least one processor, individually or in any combination, is configured to receive the indication from one of a primary cell (PCell), a primary SCell (PSCell), or an additional SCell.

14. The apparatus of claim 1, wherein the indication further indicates a second transmission of a second set of periodic SSB bursts from the SCell for a time period associated with the activated state of the SCell, wherein the second set of periodic SSB bursts is associated with a second configuration indicating at least one of:
a frequency associated with the second set of periodic SSB bursts;
a subcarrier spacing associated with the second set of periodic SSB bursts;
a periodicity or time gap associated with adjacent periodic SSB bursts in the second set of periodic SSB bursts;
a location of SSBs transmitted in each SSB burst in the second set of periodic SSB bursts;
an SSB transmission power; and
a start time and duration of a measurement window associated with the second set of periodic SSB bursts, wherein at least a periodicity associated with the second set of periodic SSB bursts is larger than a first periodicity associated with the first set of SSBs.

15. An apparatus for wireless communication at a network device, comprising:
at least one memory; and
at least one processor coupled to the at least one memory and, based at least in part on stored information that is stored in the at least one memory, the at least one processor, individually or in any combination, is configured to:
output a configuration for synchronization signal blocks (SSBs) associated with a secondary cell (SCell) for a transition period associated with a transition from a deactivated state of the SCell and an activated state of the SCell for a user equipment (UE);
output an indication that indicates a transmission of a first set of SSBs from the SCell based on the configuration associated with the transition period; and
output, during the transition period, the first set of SSBs from the SCell based on the configuration and the indication.

16. The apparatus of claim 15, wherein the indication further indicates to activate the SCell for the UE and wherein the configuration for the SSBs is a first configuration of a plurality of configurations associated with SSBs for the transition period associated with the transition from the deactivated state of at least the SCell to the activated state of at least the SCell for the UE and the indication comprises a first set of bits used to indicate whether each of a set of SCells is activated or deactivated and a second set of bits used to indicate a set of configurations for the SSBs corresponding to a subset of the set of SCells indicated to be activated by the first set of bits.

17. The apparatus of claim 15, wherein the indication further indicates an additional transmission of at least one additional set of SSBs from at least one additional SCell.

18. The apparatus of claim 15, wherein the indication is a first indication, and the at least one processor, individually or in any combination, is further configured to:
outputting a second indication activating the SCell for the UE.

19. The apparatus of claim 15, wherein to output the indication the at least one processor, individually or in any combination, is configured to output the indication via one of a medium access control (MAC) control element (CE) (MAC-CE) or downlink control information (DCI).

20. A method of wireless communication at a user equipment (UE), comprising:
receiving a configuration for synchronization signal blocks (SSBs) associated with a secondary cell (SCell) for a transition period associated with a transition from a deactivated state of the SCell to an activated state of the SCell for the UE;
receiving an indication that indicates a transmission of a first set of SSBs from the SCell based on the configuration associated with the transition period; and
measuring, during the transition period, the first set of SSBs from the SCell based on the configuration and the indication.
